(19) United States
(12) Patent Application Publication
(10) Pub. No.: US 2025/0284786 A1
(43) Pub. Date: Sep. 11, 2025

(54) METHOD AND DEVICE FOR SECURE ONLINE EDUCATION

(71) Applicant: Securetest LLC, Miami Beach, FL (US)

(72) Inventor: David Breed, Miami Beach, FL (US)

(73) Assignee: Securetest LLC, Miami Beach, FL (US)

(21) Appl. No.: 19/079,406

(22) Filed: Mar. 13, 2025

Related U.S. Application Data
(63) Continuation of application No. 18/325,172, filed on May 30, 2023, now abandoned.
Application No. 18/325,172 is a continuation-in-part of application No. 18/183,987, filed on Mar. 15, 2023, now abandoned.
Application No. 18/183,987 is a continuation-in-part of application No. 18/157,877, filed on Jan. 23, 2023, now abandoned.
(60) Provisional application No. 63/267,059, filed on Jan. 24, 2022.
(60) Provisional application No. 63/269,352, filed on Mar. 15, 2022.

(51) Int. Cl. G06F 21/32; G09B 5/06; H04L 51/02

(52) U.S. Cl. CPC G06F 21/32; G09B 5/06; H04L 51/02

(57) ABSTRACT

Method for generating an indication of completion of an education or vocational course by a registered student includes directing the student to study multiple segments of the course, and performing a test of each segment to determine comprehension thereof. Testing entails directing the student to place a headset on their head in a position in which a display is readable, performing biometric verification to verify identification of the student as the registered student, presenting test questions on the display and receiving via a user interface, a response to each question, determining passing of the test, and associating passing of the test of each segment with identification of the student and then generating and storing in a database an indication of passing of that segment. A student record in the database is updated to include an indication of course completion after indications of passing of all segments are in the database.

### CROSS-REFERENCE TO RELATED APPLICATIONS

This application is a continuation of U.S. patent application Ser. No. 18/325,172 filed May 30, 2023 which is a continuation-in-part of U.S. patent application Ser. No. 18/183,987 filed Mar. 15, 2023, which claims priority of U.S. provisional patent application Ser. No. 63/269,352 filed Mar. 15, 2022, now expired, and is a continuation-in-part of U.S. patent application Ser. No. 18/157,877 filed Jan. 23, 2023, which claims priority of U.S. provisional patent application Ser. No. 63/267,059 filed Jan. 24, 2022, now expired, all of which are incorporated by reference herein.

### FIELD OF THE INVENTION

The present invention relates generally to the field of computer-based apparatus, systems, and methods for providing an efficient and secure education to a student. This invention provides a combination of textbook guidance and tests that are dynamically tailored to the student to maximize his/her learning of the course material without help from another person. Some of the course tests are provided using a device for displaying tests that has not been breached and is not being breached or otherwise compromised. Some of the course not-for-credit quizzes are presented in a non-secure fashion to indicate the student's progress.

The present invention also relates to a method of personalized learning whereby the teaching pace is matched to the student's ability and where progression through the course is based on demonstrated mastery of the material taught so far.

The present invention also relates generally to the field of online education where the contents of the tests are confidential, and an unauthorized student is not permitted to view the tests.

The present invention also relates to the use of an IP tutor, such as ChatGPT, to assist the student to learn the course material and includes answering questions.

Finally, the present invention allows for the viewer or test-taker to proceed to completion of the test if a failure of the connection to the internet occurs.

### BACKGROUND OF THE INVENTION

There has been significant discussion over the past several years relating to MOOCs, Massive Open Online Courses. Using the Internet, education can be freely distributed to anyone who has Internet access. Mastery of almost any field taught in any schools including high schools, colleges and universities can be achieved by a motivated student without attending lectures at a school. Thus, technology is in place for a student to obtain, at virtually no cost, knowledge that has previously only been available to a campus-resident, matriculated student at a college, university, or other institution. However, very few students have received college credits or degrees based on MOOCs and it is generally recognized that MOOCs are a poor teaching method.

In contrast, the cost of a traditional Massachusetts Institute of Technology (MIT) education, for example, resulting in a bachelor's degree can approach or exceed two hundred thousand US dollars. A major impediment which exists from preventing a university such as MIT from granting a degree to an online-taught student is that the university needs to know with absolute certainty that the student did not cheat when taking various examinations required to demonstrate mastery of the coursework. With a degree from MIT, for example, industry will hire such a person at a starting salary approaching or exceeding $100,000 per year. Thus, the value to the student is enormous. Since the information which must be mastered is now available for free on the Internet, the main impediment separating a motivated and capable student from a high starting salary is that a degree-granting school must be certain that the student has demonstrated mastery of the material through successful completion of examinations without the assistance of a helper or consultant while taking the examinations.

However, the progress of the student through such online courses is often fixed and independent of the capabilities of the student. As a result, a capable student is retarded in his/her education and a less capable student can get lost and not finish the course.

For a student to take a course provided according to the teachings of the invention described herein, a student can register to take a course and is loaned or sold a headset. The headset guides him or her through a complete course with frequent tests. If he or she misses a question on a test, he or she can be provided more instruction until he or she gets a near perfect score on the test after which he or she can go forward. The headset prevents him or her from cheating on the tests and the questions can be changed each time he or she takes a particular test. Once he or she passes the test, he or she can go on to the next section of the course. He or she can quit the course at any point and receive a grade that is based on how far he or she progressed through the course. If he or she completed the course, he or she gets an A. This concept is partially described in the book The One World Schoolhouse by Salman Khan although he did not know of the headset described herein and thus his concept is impractical to apply. Let us now review some of the critical educational issues.

Most of the learning can take place using software including quizzes that guide the student and determine that the student is learning the subject matter. This process can be done using any computer connected to the internet site having the appropriate software. Many quiz questions can be presented which need not be graded or be part of the student's record. This part of the teaching process is meant to guide the student through the learning of the subject matter. When the student demonstrates through passing of quizzes that he or she has mastered the material in the section, the student can proceed to a secure test which if passed will allow the student to proceed to the next section.

Let us begin with the education industry.

The purpose of education is to prepare students for a successful life. This usually means earning a living, which usually means becoming employed. Most people work for a company or other organization which hires people having the skills necessary for the company to succeed. When such an organization decides that they need to hire one or more new employees, they usually know what skills that such new hires should possess. Children begin life with essentially no skills, and therefore the skills needed to make a living must be acquired either from parents or schools or other educational system. Here, we are concerned with the skills taught by schools.

There are reasons for attending schools other than acquiring skills such as athletics, meeting future life-long friends, finding a wife or husband etc. Here, we will be concerned only with those skills that lead to employment by a company or other organization.

Unfortunately, many of the courses taught in many schools do not efficiently prepare students with the skills needed by employing institutions. The course curriculum is more and more being influenced by political and ideological factors resulting in degradation of the quality of education that students are getting in high schools and colleges in the United States. There are many studies that quantize this trend which do not need to be repeated here. There is a need to disrupt the current education system to improve the outcomes.

Furthermore, the cost of an education has skyrocketed far ahead of inflation. This additional cost is not going to hire better teachers but rather to the administrative staff of the schools as has been reported by several studies. The US Government has exacerbated the problem by guaranteeing student loans so there is no longer a need for banks and other lenders to ascertain the ability of a student to repay a loan. Thus, tuition has substantially increased and student debt now exceeds credit card debt and puts enormous burden on graduating students.

The knowledge necessary for mastering most non-manual skills is now available for free on the Internet or for a small fee in readily available textbooks. The education industry operates to take this mostly free information and organize it in a manner that can be presented to students so that they can obtain the skills referred to above. It is obvious that the system has failed. They take mostly free information and sell it for a lot of money and still do a poor job preparing students for employment. An object of this invention is to create an education system and apparatus which is very low cost and greatly improves the process of preparing students for successful employment.

### Schools

Schools differ in the manner that education is delivered. In some schools, such as the Harvard Business School, the education is delivered primarily though the case method. The students are assigned a case where there is no clear solution to the problems facing a company's management. The students then meet and discuss various methods of improving the situation that the company is in. The professor guides the discussion, and the theory is that through this method the students gain experience in solving real world problems facing companies. In other schools, such as the MIT Sloan school, the students are taught skills such as accounting, marketing, advertising, statistics, business management techniques and case studies and class discussions are minimized. The techniques described in this invention apply primarily to the latter teaching approach. The goal is to teach skills in the most efficient manner.

For example, it is not practical or efficient to teach students calculus through the case method. On the other hand, it is difficult to teach human relations management through the skills method. A student, on the other hand, spends his entire life interacting with other people and thus it is difficult to see how the case method can compete with the knowledge that a student achieves though his lifetime. Thus, the case method is at best very inefficient and at worst a waste of time. The invention is thus directed to teaching skills.

Schools also differ in the time allotted for a student to achieve a desired skill level. Some schools are designed for the student to devote a high percentage of his time to learning and the student generally resides on or near campus at such institutions. Other schools are structured to allow the students to attend classes at night, for example, and to spread the attainment of a degree out over many years. In still other cases, online schools teach completely through online courses. The present invention is thus mainly directed to online teaching although it is also applicable to on campus teaching.

Additionally, some schools are structured for a particular purpose to teach one or more particular skills, such as trade schools. This invention has limited applicability to such trade schools that teach a student how to operate a particular machine, for example.

Essentially all existing schools allocate a certain amount of time to teach a subject to all students in the class. Since the abilities of students vary significantly, such a structure necessarily will be too slow for some students and too fast for others. Thus, it is by nature very inefficient. Furthermore, a great deal of expense is incurred to provide this learning environment which is a tremendous waste of time and resources. This invention greatly reduces the cost of an education and generally the amount of time needed to achieve a given level of skills.

Finally, a tremendous about of cheating occurs in most educational institutions. A great deal of money is being expended to attempt to limit cheating though proctoring systems. Generally, these systems have failed. This invention eliminates cheating.

This invention is aimed at teaching skills and thus there is no place for political or ideological influences. Facts and not opinions are being taught. Unlike many existing schools, the subjects taught are limited, as much as possible, to skills based on established facts or well thought-out established theories.

Although both are presented online, the courses taught when practicing this invention differ significantly from MOOCs. A student can watch a complete MOOC course from beginning to end and hardly learn anything. The online courses taught according to this invention, on the other hand, are mainly based on textbooks and continuously test the student to ascertain that he is learning the subject matter. If the student does not pass a test, he is not permitted to proceed with the course. There can be lectures, videos or other audio/visual aids which can be proprietary, although they exactly follow a text which is not proprietary.

Many quiz questions are presented in the texts and online during the learning portion of a section of the course. These quizzes are meant for learning purposes and are not graded for credit purposes. Since they are not for credit, cheating makes no sense, and a student is free to get help in taking the quizzes. When the student has competed studying a course section, he can be given a short quiz containing new questions to show that he is ready for the section test. At this point, he invokes the SecureTest® portion of the software and, using a secure headset, takes a test of questions chosen created to test the student's knowledge of the section. The secured tests are structured so that no test is given more than once. The test questions for a test are randomly chosen from a large list and the answer choices are randomized such that the probability of there being two identical tests is very small. The headset used by the student does not permit copying a test or transmitting it to another person. If the student wants to skim a course without getting credit, then he is free to do so using the textbook. Nothing is presented in videos, lectures, or other ancillary information upon which a student is later tested that is not also presented in the textbook. A student cannot get credit for the course just by listening to the lectures.

### How we Learn

A good understanding of how the brain works can be found in the book, How to Create a Mind, by Ray Kurzweil. From this book, a concept of how we learn can be obtained. One cannot create an efficient educational institution without a theory of how we learn. There are many such conflicting theories. The theory that underlays this invention will be described here.

The most important thing when learning is to have some basic stored information in memory where the new information can be linked. Learning something that is totally new is much more difficult than learning information that is relevant to previously learned information. In mathematics, for example, it is very difficult if not impossible to learn new information that requires an understanding of lower-level mathematics without that knowledge. You cannot study differential equations, for example, without a basis in calculus. When a student begins learning a new subject, the school should test the student to see whether he has the relevant background information to understand the new subject. While testing these students' background information, the school should also test the capability of the student to understand the new subject matter. It should also test the level of interest that the student has in the new information. If the student is simply not in the slightest interested in the material, then it is unlikely that these students will progress through learning the subject matter.

Some subjects require merely repetition for the student to commit the material to memory. Other subjects require that the student use the new information to solve problems. Problem solving can be as simple as inserting numerical values into an equation. In other cases, problem solving requires that the student use much of his previous experience to innovate a totally novel solution. It is very difficult to teach a student how to innovate and similarly to test whether in fact he has innovated a new solution to the problem. This may be beyond the capabilities of most schools.

U.S. Pat. No. 5,565,316 (Kershaw et al.) describes a system and method for computer-based testing. A test development system produces a computerized test, and a test delivery system delivers the computerized test to an examinee's workstation. The method comprises producing a computerized test, delivering the computerized test to a student and recording the student's responses to questions presented to the student during the delivery of the computerized test. A method of delivering a computerized test is also provided in which a standardized test is created, an electronic form of the test is then prepared, the items of the test are presented to a student on a workstation display and the student's responses are accepted and recorded. A method of administering a computerized test is further provided in which a computerized test is installed on a workstation and then the delivery of the test to a student is initiated. In spite of this, effective cheating prevention of the type disclosed below in FIG. 1, is not provided.

U.S. Pat. No. 5,915,973 (Hoehn-Saric et al.) describes a system for controlling administration of remotely proctored, secure examinations at a remote test station, and a method for administering examinations. The system includes a central station, a registration station and a remote testing station. The central station includes (a) storage device for storing data, including test question data and verified biometric data, and (b) a data processor, operably connected to the storage device, for comparing test-taker biometric data with stored, verified biometric data. The remote test station includes (a) a data processor, (b) a data storage device, operably connected to the data processor, for storing input data. (c) a biometric measurement device for inputting test-taker biometric data to the processor, (d) a display for displaying test question data. (e) an input for inputting test response data to the processor, (f) a recorder for recording proctoring data of a testing event, and (g) a communication link for communicating with the central station, for receiving test question data from the central station, and for communicating test-taker biometric data, test response data, and proctoring data to the central station. Verification of the test-taker and validation of the results are performed before or after the testing event. Again, effective cheating prevention of the type disclosed below in FIG. 1, is not provided.

U.S. Pat. No. 5,947,747 (Walker et al.) describes methods and apparatus for computer-based evaluation of a test-taker's performance with respect to selected comparative norms. The system includes a home testing computer for transmitting the test-taker's test results to a central computer which derives a performance assessment of the test-taker. The performance assessment can be standardized or customized, as well as relative or absolute. The transmitted test results reliably associate the student with his test results, using encoding, user identification, or corroborative techniques to deter fraud. For example, the system allows a parentally-controlled reward system such that children who reach specified objectives can claim an award that parents are confident was fairly and honestly earned without the parent being required to proctor the testing. Fraud, and the need for proctoring, is also deterred during multiple students testing via an option for simultaneous testing of geographically dispersed test-takers. Again, effective cheating prevention is not provided.

U.S. Pat. No. 7,069,586 (Winneg et al.) describes a method and system for securely executing an application on a computer system such that a user cannot access or view unauthorized content available on or accessible using the computer system. To securely execute the application, such method and system may terminate any unauthorized processes executing (i.e., running) on the computer system application prior to execution of the application, and may configure the application such that unauthorized content cannot be accessed, including configuring the application such that unauthorized processes cannot be initiated (i.e., launched) by the application. Further, such system and method terminates any unauthorized processes detected during execution of the application and disables any functions of the computer system that can access unauthorized content, including disabling any functions capable of initiating processes on the computer system. The application being securely executed may be any of a variety of types of applications, for example, an application for receiving answers to questions of an examination (i.e., an exam-taking application). Securely executing an application may be used for purposes, including to assist preventing students from cheating on exams, to assist preventing students from not paying attention in class, to assist preventing employees from wasting time at work, and to assist preventing children from viewing content that their parents deem inappropriate. Despite all the above stated precautions, effective cheating prevention is not provided.

U.S. Pat. No. 7,257,557 (Hulick) describes a method, program and system for administering tests in a distributed data processing network in which predetermined test content and multimedia support material are combined into a single encrypted test file. The multimedia support may include visual and audio files for presenting test questions. The encrypted test file is exported to at least one remote test location. The test locations import and decrypt the encrypted test file and load the test content and multimedia support material into a local database. The test is administered on client workstations at the testing location, wherein the test may include audio questions and verbal responses by participants. During testing, biometric data about test participants is recorded and associated with the test files and participant identification. After the test is completed, the completed test results, including verbal responses and biometric data, are combined into a single encrypted results file exported to a remote evaluation location. The evaluation location imports and decrypts the encrypted results file and loads the test results into a local database for grading. Again, despite the above stated precautions, effective cheating prevention is not provided.

U.S. Pat. Appln. Publ. No. 2007/0117083 (Winneg et al.) describes systems, methods and apparatus for remotely monitoring examinations. Examinations are authored and rules are attributed to the exams that determine how the exams are to be administered. Proctors monitor exam takers from remote locations by receiving data indicative of the environment in which the exam takers are completing the exams. A remote exam monitoring device captures video, audio and/or authentication data and transmits the data to a remote proctor and data analysis system. Despite proctors, effective cheating prevention is not provided.

U.S. Pat. No. 10,359,647 (Vasiliev et al.) and U.S. Pat. Appln. Publ. No. 20200050023 (Vasiliev et al.) assigned to iGlass Technology, Inc. utilize electrochromic technology to control transmission of light from the environment to the eyes of the wearer for the purpose, among others, of preventing an observer other than the wearer from observing the contents of the display. No provision is made for preventing the observer from physically removing a portion of the electrochromic layer to provide a window through the electrochromic layer thus exposing access to a projected display if present and allowing placement of a camera, for example, which can observe the display contents and supply that information to a consultant assisting the student in taking the test. Effective cheating prevention is not provided.

Despite these and other patents and applications that describe methods of preventing cheating on examinations, a brief Google search reveals that cheating on examinations is prevalent worldwide. Thus, these inventions have not been successful in eliminating cheating on examinations. For example, recently students taking examinations for credit in connection with MOOCs have found that they can register many times for a course and collect and combine the results of multiple simultaneous examinations to compose a single correctly answered test for submission for credit. This is known as Cameo cheating.

The following companies, among others, provide proctor services during exam/tests:
ProctorU—https://www.proctoru.com/
Kryterion—acquired by Pearson in 2015—https://www.onlineproctoring.com/
Examity—http://examity.com/
Pearson Vue—both online proctored test and a network of physical test centers—https://home.pearsonvue.com/
Proctorio—https://proctorio.com
B Virtual Inc.—https://bvirtualinc.com/
Question Mark Online Proctoring—https://www.questionmark.com/content/online-proctoring-service

### OBJECTS AND SUMMARY OF THE INVENTION

An object of at least one embodiment of the present invention is to apply the test security inventions described in the inventor's and assignee's patents and applications mentioned herein to creating education methods and systems to allow the granting of credit to students taking online courses.

Variations and improvements on the above-described headset and disclosed in other of inventor's and assignee's patents and patent applications are applicable to this invention as are other designs which permit secure testing and/or lecture viewing which were not available prior to assignee's inventions.

Several education methods and systems which are described herein when used in conjunction with inventor's and assignee's inventions mentioned herein permit the secure granting of credit to students taking online courses and the matching of the course presentation rate to the learning rate capability of the student. This permits dramatic efficiency improvement and reduction of the cost of education and thus makes it widely available to students worldwide which heretofore has not been possible.

One method for controlling the pace of teaching to a plurality of students includes providing each student with a respective headset that provides the same set of sequential instructive material, monitoring progress of each student exposed to each discrete part of the instructive material via feedback obtained from the monitors, and assessing, using a processor, whether each student has satisfactorily completed understanding of each discrete part of the instructive material. Each student can advance to a subsequent part of the instructive material only after the assessment has determined that the student has satisfactorily completed understanding of an immediately preceding discrete part of the instructive material. Completion by each student of the instructive material is determined and then a record of completion is provided. As such, each student advances independently of other students.

In some embodiments, prior to providing the same set of instructive material to each student, it is determined whether each student has prerequisites to receive the set of instructive material. Questions may be directed to each student to assess their ability to understand the set of instructive material prior to providing the same set of instructive material to each student. The set of instructive material can include at least one test, in which case, assessing, using a processor, whether each student has satisfactorily completed understanding of each discrete part of the instructive material entails requiring the student to take and pass the at least one test using the monitor.

The instructive matter to be learned by the student generally is recorded in a written textbook. Generally, the student will study the textbook and interact with a computer program which continuously tests the student's understanding of the subject matter. These non-credit tests are an important part of the education process. When the software determines that the student has sufficiently mastered the subject matter of a given subject section of the textbook, then the student will have the option of taking a test to determine credit for the section of the textbook that has been studied. This test will be provided using the headset that is designed to prevent cheating on this test, the SecureTest® system, for example. If the student passes this secure test, then he can advance to the next section of the textbook. During this learning process using the software, under control of the student, various learning assistance can be provided using lectures, recorded videos, and other audio-visual aids, as well as an AI tutorial system using ChatGPT, or other AI question answering systems. None of these aids require the use of a teacher and thus are under the control of the student. If the student does not understand some concept in the text, he can ask the AI chat system any number of questions until he has acquired the missing understanding. The AI chat system thus in a sense replaces a live tutor or a teacher.

Using the software, it is possible for the student to repeat parts of the set of instructive material until the software determines that the student is ready for the section credit test. Then, using the monitor, the student takes a secure test upon control of a user interface. Upon passing the secure test, the student is permitted to advance to the next textbook section. If these student does not pass the test, he is instructed to restudy the section in the textbook until he is ready to retake the test. In this case, a different test is provided to the student each time the student repeats parts of the set of instructive material.

The rate at which tests are directed to each headset to be taken by each student is adjustable. The instructive material may be presented to each student as a function of the passage of tests.

Each set of instructive material may be a different course, and each course may be sourced from a different course-providing institution. An accredited degree program can be constructed from a plurality of courses. These courses can comprise standard school on campus courses, lecture courses provided on the Internet, and the lecture free courses described herein.

The course test material is preferably provided to each headset in an encrypted format that is only decryptable at each headset. Also, using the headset, it is possible to limit viewing and/or hearing of the set of instructive material to a single user of each headset and verify usage of the monitors using biometric data.

### BRIEF DESCRIPTION OF THE DRAWINGS

The following drawings are illustrative of embodiments of the systems and methods developed or adapted using the teachings of at least one of the embodiments disclosed herein and are not meant to limit the scope of the disclosure as encompassed by the claims.

FIG. 1 illustrates some possible cheating methods used by a test-taker.

FIGS. 2 and 3 show forward and back views of a headset device of the invention.

FIG. 4 is a chassis intrusion detector design and its assembly sequence.

FIG. 5 shows the unassembled headset housing.

FIG. 6 shows the chassis intrusion detector operating principle.

FIGS. 7A, 7B, 7C, 7D, 7E and 7F illustrate a preferred design of the headset for two eyes utilizing a single display.

FIGS. 8A, 8B, 8C, 8D, 8E, 8F, 8G, 8H and 8I illustrate a preferred design of the headset for two eyes utilizing two large displays.

FIGS. 9A, 9B, 9C and 9D illustrate the device of FIGS. 8A-8I with the chassis intrusion detector installed.

FIG. 10 illustrates a combiner assembly with a CID and blocking film.

FIG. 11 illustrates a flex circuit connector cable passing through CID joint to connect to a circuit on a printed circuit board.

FIG. 12 illustrates a system block diagram.

FIG. 13 illustrates a representative administrative sequence.

FIG. 14 illustrates a representative test-taking sequence.

FIG. 15 is a flow chart showing the way a test can be taken using a headset in accordance with the invention in consideration of possible interruptions in Internet-connectivity during the test.

FIG. 16 is a flow chart showing the way a lecture can be viewed using a headset in accordance with the invention in consideration of possible interruptions in Internet-connectivity during the lecture.

FIG. 17 shows an alternate headset design using lenses.

FIGS. 18A, 18B, 18C and 18D show an alternate headset design using quantum dots and meta lenses.

FIG. 19 illustrates the steps for managing taking of a secure course by a student.

### DETAILED DESCRIPTION OF THE INVENTION

Consider a course that is taught based on a textbook. The textbook contains pages and on these pages are nuggets of information which the student should commit to memory. Assume that a textbook contains 1,000 such nuggets. These nuggets can be numbered. The nuggets can be grouped into the information that comprises sections. For example, nuggets 1 to 30 can comprise section 1. For section 1, therefore, the teaching software would concentrate on nuggets 1 through 30 and the students would be expected to learn those nuggets from the textbook and/or the exercises and audio-visual aids provided by the teaching software. At some point, the student will be presented with a sample quiz on the content of section 1. The quiz can contain new questions that cover a random portion of the section 1 content to determine if the student is ready for a test covering section 1. If the student passes the quiz, he is then required to wear a secure test headset, as discussed below, and a secure test for credit covering the section is administered.

A secure test question may concentrate on one or a combination of nuggets. In fact, for every such grouping of nuggets comprising a test question, multiple test questions can be created covering the same nuggets. Thus, the test can be restructured multiple times without repeating the same questions. As the course develops, secure tests can not only comprise questions from the most recent sections, but a sampling of questions from previous sections can be interspersed. Thus, each secure test in addition to covering the most recent material can also contain a percentage of questions from previous lectures to determine whether the student has retained the previously taught information.

It may require the mastery of a significant number of nuggets before a student obtains a skill which can be used in solving a problem. Once the proper number of nuggets have been mastered by the student, he should be capable of using his acquired skill to solve a particular problem. Thus, a question on a secure test can involve a few nuggets or skill acquired by learning many nuggets. If a student is unsuccessful in answering such a problem-solving question, then additional secure test questions can be formed to determine which of the nuggets the student has not mastered. Thus, a later secure test can have questions that relate to the missed questions from a previous secure test.

If only one student fails to properly answer a particular problem, then the fault lay in the student's mastery of previously taught nuggets. However, if a significant number of students fail to properly answer a particular problem, then the fault may lie in the way in which the nuggets were taught to the students. This opens the opportunity for continuous improvement in the way the course is taught, and the textbooks written. During the learning part of the section, there can be the opportunity for students to pose questions to the AI tutor. If several nearly identical questions are posed, then the course needs to be revised since the students are not learning the information covered by those questions. If only a single problem is asked through the questions, a response to the student can comprise a suggestion to study certain of the nuggets related to that question. In the case where the student is not able to comprehend the information, the suggestion can be made that the student contact an available tutor.

It is contemplated that all the information which is required for a student to master the course will be presented in the textbook. No additional information needs to be delivered by a professor through lectures. Similarly, although some professors may wish to provide some additional information through PowerPoint slides or audio video presentations, the students are not expected to master any of the material that is not in the textbook. Lectures are optional and not a required part of the course. This will discourage the use of other forms of information presentation and thus keep any lectures simple and focused on the teaching of nuggets. There will generally be no homework assignments given to the students which will be graded by the school. Since the system described herein is for online teaching, the school has no control over whether the student acted alone in comprising answers to his homework assignment or got help from a consultant. Professors may very well suggest that students practice solving problems that are written in the textbook, but there will be no credit given for solving those problems. The purpose of the problems is to aid the student in developing skills.

All quizzes will be answered online with no credit. Course tests will use the secure test headset with all its security provisions. Thus, no two students will have the same secure test since the questions and answers will be scrambled and randomly selected from a larger list. Additionally, when tests are not given simultaneously, the test questions themselves will change from test to test. Each student will be given the opportunity to take a secure test as often as he or she wishes up to the point where it is clear that the student has not mastered the information. Similarly, the student can listen to any course lectures or other related audio or visual information and use the AI Chatbot as a tutor as often as desired.

When the student enrolls in a course, there will be a tuition charge paid to the school. Additionally, the student will be required to purchase a SecureTest® headset or similar device. There will be an additional charge for using the system which can be in the form of a charge for the time connected to the course providing server or for a one time per course charge regardless of usage.

The system will also comprise a learning management system (LMS). This LMS will be used in conjunction with the school's LMS. Therefore, a coupling of the two LMS systems will need to be created for each school. The LMS described here will be very simple since there is no need for submitting homework assignments or carrying on group chats among the students, for example.

A particular school can, within the confines of this system, devise its own grading system. A preferred system is where students are not permitted to proceed through the course until they have mastered the already taught material. Under this system, every student should have mastered the course by the time they finish. Thus, grades have no meaning and every student who completes the course automatically receives an A. This also automatically adjusts the speed of the course to the capabilities of the student. Some students, for example, can complete the course perhaps in a month whereas others might require a year. The ability and the availability of time for each student does not handicap him in learning the course material. Additionally, the capabilities of other students in the class do not affect the progress of a particular student.

### Schools

The status of colleges and universities today in the United States is dismal. The cost of education has far outpaced inflation. The Federal government has chosen to guarantee student loans with the effect that schools do not have to assess the creditworthiness of a potential student. A student in a course that is unlikely to yield significant income to the student after graduation can get a U.S. government guaranteed loan. Thus, schools can charge any tuition amount that they wish knowing that there is no risk of default. Similarly, banks do not have to assess the creditworthiness of the student. The effect of this is to channel students into majors that have no significant economic value to the country. Similarly, students have little idea what majors will pay high enough salaries to allow them to repay their student loans.

Since schools now are heavily influenced by government subsidies of the student loan program, they no longer need to consider training students who will be economic contributors to the country and thus will later contribute to the support of the college or university. The staff of colleges and universities have grown way out of proportion to the teaching required by the university. The staff are frequently hired based on political considerations rather than educational. Nepotism related to admissions, scholarships and staff hiring is rampant. Spending on administrators and administration exceeds spending on faculty, administrators out-number faculty, and administrative salaries and benefit packages, particularly those of presidents and other senior managers, have skyrocketed over the last 10 years. The quality of United States educational institutions has been steadily declining on the world scale. Importantly, industry can no longer rely on college achievements of potential hires. From the late 1990s, many university departments have reduced the requirements for coursework such that professors report being told what not to have their students read or write. The result of such policies is that higher education often resembles an encounter session: Show up, smile, and look vaguely interested in the subject and you can be fairly certain of getting a decent final grade. The role of the student is that of financial broker. Furthermore, the subjects taught are now heavily influenced by political and ideological factors which have no value in training a student for future work in industry.

From admission to completion of the degree, there are innumerable industries built around making as much money from students as humanly possible and the larger university structure turns a blind eye to this. More to the point, technology is playing a major role in how it enables this academic cheating with myriad online industries established around every facet of academia from entrance exams to coursework and final papers, to theses.

Additionally, schools are more and more becoming less rigorous. This started with the Harvard Business School and now has been adopted by the San Francisco startup Minerva which is the most selective school in the country. Rather than teaching problem solving skills, students at Minerva meet to discuss solving problems when none of these students have any background for solving such problems and the professors similarly have not participated in industry where real problems are encountered.

These problems are solved by this invention where a school designed according to the teachings of this invention can operate anywhere in the world and teach the same subject. A person in Bangladesh who passes such a course would have the same prestige as a person who studied in California. The idea of collecting all of one's knowledge and skills, regardless of where they are acquired, into a single meaningful credential is relatively new. The fact that colleges currently have a near-monopoly on degrees that lead to jobs goes a long way toward explaining how they can continue raising prices every year. The present invention solves any of the problems described above as will become evident.

A school designed according to the teachings of this invention will be capable of providing high quality educational services and at a small fraction of the cost of existing colleges and universities. There will be no need for buildings or extraneous staff. Once the course textbook and associated learning materials have been developed, there is no limit to the number of students that can utilize this information. As the number of students studying a particular course increase, the cost per student course decreases. The quality of the educational result will be beyond that achievable by current colleges and universities the way they are now structured. A student will not be permitted to proceed through a course until he/she has mastered the information previously presented.

The quality of a course as described herein is independent of the skill of the faculty of any university. A course developed at MIT will be equivalent to a course developed at the University of Miami. Similarly, a degree can comprise courses that have been developed from several different universities and yet the quality of the degree will be the same. All these facts will serve to substantially reduce the cost of achieving an education. Additionally, the quality of the degree will be unassailable. There can be no cheating involved in obtaining the degree. Also, no student will be permitted to complete the course without having mastered all the subject matter that comprises the course. Every student that completes the course will be an A student.

### How we Learn

As discussed briefly above, clues as to how to learn can be derived from a theory of the mind such as the one described in How to Create a Mind by Ray Kurzweil. An alternate approach when developing a course would be to try different approaches and measure the results. In designing a course, nuggets of information will be presented to the student and his ability to retain that information will be tested shortly after the information has been presented. By comparing the initial test results from many students, empirical measurements of different teaching techniques will emerge. As the course is being developed, it can be modified to improve retention by these students. For cases where the student cannot understand the subject matter, access to an AI tutor is provided. Initially, numerous questions may be expected, and these will factor into modifying the course to improve the presentation of the information to be learned. This can be done by creating a new textbook edition and through supplementary information until the textbook revision occurs. After several iterations, the number of questions should approach zero. Occasionally, there will be a student who just does not understand the subject matter. In that case, additional testing of that student's innate capability will indicate that the student should not attempt to learn a particular subject and therefore should change his major.

There are many theories of how students learn; various of these theories can be tested using the methods described herein. That is, a new learning theory can be used to construct several nuggets and the results of the student tests will determine whether that learning method was an improvement or not.

Some students may have the innate capability of learning a subject but due to a learning disability or a language problem, learning of a particular set of nuggets may be difficult. If the disability or problem is limited to a small percentage of the nuggets, then the student can proceed with the course after spending considerably more effort on the problem nuggets. For cases where there is a general problem, then the student should consider leaving the course. Prior to starting a course, a student can be tested to see if there are any innate problems that will significantly interfere with the student's ability to master the subject matter. Again, in such circumstances, the student might be well advised to follow a different educational path. This can be determined before a great deal of cost and effort has been expended trying to teach material that the student does not have the capacity to learn.

Since there is a vast literature on how to teach and how to learn, it is impossible to incorporate very many of the teachings of this literature into the development of a course. The course construction technique described herein is open to testing various teaching and learning techniques and to quickly determine their validity. Those that are valid can be incorporated and those that are not can be dismissed. Since students of a particular course will be progressing at different speeds, techniques involving students discussing the subject matter with each other cannot be incorporated. However, if it is found that a certain group of students having a testable characteristic can learn by a different method than other students with a different testable characteristic, then as this program develops students can be tested for this characteristic and placed in different subgroups of the course that is tailored more to their capabilities. All students must exit the course with the same proficiency even if it is achieved by different paths.

According to one reference, people generally remember only 10 percent of what they see, 20 percent of what they hear, and 30 percent of what we read, but as much as 90 percent of what they do or experience. The problem with this formula is that having students do or experience the subject matter can be very time consuming. Although the retention rate may be much higher, if the metric is the amount retained per hour, the advantage of experience is significantly reduced. Of course, a great deal depends on the nature of the course. It is impossible to teach surgery, for example, without hands-on experience. In some courses, such as computer science, programming skills can be experienced relatively easily and therefore it should be a part of a course on computer science. This generally falls under the heading of homework. If homework is not graded, then students are reluctant to spend their time doing homework. If it is graded, then students are tempted to get the help of a consultant, or a company set up for solving students' homework problems. This latter example is called cheating. Homework problems can be assigned and an indication of whether the student did the homework assignment can be ascertained somewhat by testing for the principles which would have emerged had the student done the exercises. Secure test questions can be used to determine whether the student learned from doing homework.

A significant advantage of the course as taught herein is that a student can ask as many questions of the AI tutor as he wishes. More importantly, this student generally will not just read the assigned written material but will mark it, take notes, and further consolidate the information so that for review purposes, the amount of information that needs to be reviewed is very limited. As a result, learning from written material quickly becomes far more efficient than attending lectures. A student need not take notes from the oral lectures since if watched, nothing will be presented in the lectures that does not also appear in the textbook. Generally, students will skip oral lectures if they are presented.

Since doing or experiencing is a much more powerful educational factor than listening or reading, many courses in STEM education require that the student perform sample analysis or problem solving. After the student has solved 10 problems using a newly learned concept, the time required for the student to solve another problem should be substantially reduced. The 11th problem can be presented as part of a software-provided quiz and the time it takes the student to solve that problem can be measured as an indicator of whether the student in fact solved the previously assigned 10 homework problems. Thus, the time required to solve a problem on a test is an indicator of how much the student learned doing the homework problems. Students who spent the most time answering practice problems do far better than those who watch lecture videos or lectures.

Prior to the launch of a course, testing of each student should determine whether that student has the requisite background to undertake the new course. For those students missing a substantial amount of the prerequisite skills, entry into the course can be denied and the student directed to a lower-level course. For those students that have most of the requisite knowledge but are missing a few key areas, the student can be directed to sub courses directed to solving the problems that a student possesses. As the course proceeds, it will frequently be found that certain students have difficulty mastering a particular concept. Again, sub courses can be provided to give special attention to such students. Additionally, the AI tutor should be able to answer any issues. The assumption for this invention is that once a course commences, all the students in that course have the prerequisite information to successfully complete the course.

### Motivation—why we Learn

Although there are any reasons why a student attends higher education, we will assume here that the reason is to get a good paying job. Thus, a prime objective of this invention is to match industry needs to student's courses and then guarantee jobs for the students that successfully pass the courses. The work-reward path is that the student studies hard and gets a degree which allows him to get a good paying job. This path needs to be clear. The student needs to know in advance what reward to expect to motivate him to succeed.

Part of the problem is the accreditation system. It's hardly surprising that frustrated employers are looking to create an alternative to accreditation as a quality measure of the skills of college graduates. Accreditation has been attacked as a barrier to innovation and improvement in higher education. A 2013 Gallup/Lumina survey documents the profound disconnect in views of quality. Just 11 percent of business leaders believe college graduates are properly equipped for entering the workforce while 96 percent of college chief academic officers feel they turn out to be work-ready graduates. The Chamber of Commerce Foundation report is correct in criticizing accreditation as “operated by higher education for higher education” rather than as a quality measurement in tune with the needs of employers and would-be employees. A key motivation of this invention is to create graduates that have mastered the skills required for employment in industry. The student should have no doubt what the resulting job should pay, and the company should have no doubt concerning the qualifications of the graduate.

Colleges using the system described herein and employers need to work together to continuously improve the systems described herein and develop performance measures to assure that graduates have the workforce skills they need. A challenge facing these alternatives to accreditation is that Pell Grants and federal student loans can only be used at accredited institutions. Teaching using the methods described herein will substantially reduce the cost of getting an education and industry may be willing to cover the costs of future hires. The system of this invention gives a credential that proves that the student knows the subject. Before someone signs up for a course, he/she should know what financial benefit will result. Most students (86 percent) now say their main reason for coming to college is to get a good job. A growing number of colleges and universities are guaranteeing a job after graduation. That number should significantly increase through adoption of teachings of this invention.

### Course Structure

A key element of the structure of the courses described herein is to greatly increase the efficiency of obtaining an education. Why should the student be forced to waste time attending lectures which may cover information that he already knows. Similarly, why should the student waste time traveling to and from a classroom when he could be learning the course material at home. Additionally, why should a student who is brighter than the average of a class be forced to have the pace of his education determined by the average ability of students in the class. In addition to the cost of attending classes, there is substantial opportunity cost resulting from the fact that if the student's education is delayed for any of the reasons discussed herein, he/she is losing valuable income which he would earn once he/she completes his education. The course described herein is therefore structured to, in the most efficient manner, educate a student and prepare him for gainful employment.

The facilitator or lecturer role usually extends beyond just course delivery, and includes broader pedagogical tasks of welcoming students, helping students manage time and feel comfortable, being responsive to students' needs, being “present” in online activities or forums, communicating or checking in with students as needed, assigning activities and formative activities, providing timely, actionable, and substantive feedback, and fostering student engagement, interest, and interaction. These tasks need to be minimized through the design of the course. There should not be any lecturers and if there are they should only lecture once and that should be pre-recorded and not require redoing for each new class of students. Most of the above actions should be automated and the remaining few handled by school staff. If a student needs special handholding, he should be charged for that service.

There is no need to hire rockstar professors since all the information to be learned will exist in the textbooks. If a prestigious school feels the need for high paid professors, then the students will be charged more for the same education.

Teach writing and speaking separately since they are skills like playing a musical instrument and should be taught elsewhere.

### Test Structure

Prior to taking a course a student should take a pretest to determine, for example, whether there is a learning disability, a language or cultural problem, or any other problem that might interfere with learning the course material. Foreign students may need some pre-education to adjust to US teaching methods. Some minority students are at risk for online learning attrition in higher education due to lack of academic preparation. In some cases, it may be desirable for the student to try the course for a period to test his capabilities of learning the material. Additionally, the school may conduct a pre-course interview to check for the potential job skills that the student will need to develop and his demeanor etc. As a minimum, every new student to the school should fill out a personalized questionnaire which attempts to determine the issues mentioned here.

Tests need to be carefully designed so that they can determine that the student really understands the material and did not just memorize it. In many cases, an intelligent student can get by with memorizing formulas without really knowing how to do things or how to understand the material being taught. Tests should be designed to determine this issue. Tests also should be designed to try to understand whether the student understands the practices, tools, and ways of thinking in the discipline. Also, how a student arrives at an answer is at least as important as generating the correct answer. This can be determined by carefully constructed test questions. Where possible, test questions should determine whether the student has reflected on the information learned and can thus make decisions and solve problems on how a particular set of problem-solving strategies is appropriate. Generally, all answers to test questions should be short, which are preferably multiple-choice questions. Tests will be machine graded.

When taking a test or at other times, a student may have questions and should be encouraged to submit those questions to the AI Chatbot. These questions will be recorded and later reviewed by the course manager as they give important clues as to whether some information is missing from the textbook and should be added.

### Other Considerations

Although the applications described herein are primarily for higher education, they can be equally applied to high school and other levels of education including trade schools etc. Similarly, they can be used for a single purpose situation such as preparing students for taking national tests such as SAT, GRE or the Chinese Gaokao annual test to determine admission to Chinese universities.

Teachings of this invention can be restricted to a particular school, in which case, the textbooks would need some form of encryption or other protection to prevent wide dissemination beyond the school. Preferably, however, once a course has been created, the course can be used by other schools either for free or through a licensing structure. This avoids the duplication of effort of creating the same course textbooks for multiple schools and facilitates the transfer of credits from one school to another. This would be a school-by-school decision. Through this sharing of courses, the cost of obtaining a college education would be drastically reduced, since there would be a minimum of duplication of effort. This also protects against bias in teaching that might result at a particular school.

In general, a course of this invention will be designed based on an available successful textbook. Nevertheless, to the extent necessary, the school facilitator can aid in adapting the course to the school or university. He/she will be the local house manager and oversee the distribution of grades and other assessments or communications with individual students. He/she will be the resident subject matter expert should any disagreements or explanations be required at the university. He/she will also serve as the interface between the school and the course designer to pass on observations that might improve the quality of the textbook.

The facilitator or other member of the school's staff can be available to advise students on their academic and professional development over and beyond what is taught in the courses. This includes instilling what the profession is about, advising on career goals and career paths, and on additional course offerings.

In a paper titled “Will Education as We Know it Be Pointless 30 Years From Now—Part 2”, a list of 11 educational pain points was presented. A review of these points as they relate to the invention disclosed herein is:
1. It's hard to learn. Courses created using the teachings of this invention very carefully lay out the material that needs to be mastered. They are presented in simple nuggets for the student to either memorize or understand. The student is quizzed by the software system with numerous questions before being allowed to take a section test.
2. It's unclear what to learn currently and going forward. Courses created using the teachings of this invention clearly present what needs to be learned at each step of the way. These are the nuggets.
3. It's hard to find the right resources to achieve your learning goals. All the sources needed to master the material are presented in the course listing. The financial resources related to matriculating at a particular school are beyond the scope of this disclosure. Nevertheless, the financial aspects should be greatly reduced due to the efficiency of this program.
4. It's unclear how to measure progress towards learning goals. Progress toward the learning goals is easily determined by how the student moves through the course. The speed of learning is completely dependent upon the motivation, ability of the student, and time availability.
5. It's difficult to figure out how to practically apply knowledge acquired. The courses will have many examples showing application of the material acquired. When the student embarks on this program, he already knows what job and salary he is aiming at, therefore there is no uncertainty concerning his goals. The student will not be permitted to start the course if he does not have the requisite native ability. If the student fails, it will be due to a lack of motivation and application on the part of the student.
6. Finding the right purpose for learning something is ambiguous. The right purpose is obvious from the beginning. The student is aiming at a particular job that is known to be available in the industry.
7. It's hard to catalog information for retrieval and retention. The student will not need to catalog the information. Since he will be continuously retested on previously learned material, proof of knowledge retention will be continuous.
8. It's hard to stay consistent with the application of knowledge. The goal of the student will be clear from the beginning and the application of the knowledge obtained should be obvious to the student as he progresses.
9. It's lacking “proper” mentorship. If the course is properly designed, mentorship should not be necessary except in very exceptional cases. For those exceptional cases, the school should provide counsellors to help a student over a rough spot. Additionally, the Chatbot tutor should resolve many of these issues.
10. It's difficult to cater to people's different learning abilities. The speed of learning through the course will depend on the ability of the student. The system automatically caters to differing learning abilities.

A few years ago, Yixue Education of China developed an AI-based tutorial system that professed to be better than human tutors in training students to pass the Chinese Gaokao test. The basis of the AI system, of course, is not known but it professed to be able to determine the weaknesses in a student's background and then to provide the necessary missing information. This is the intent of the preparatory tests described above and the Yixue AI system may be useful for that purpose. Once the student has started the course, the course itself will provide the necessary missing information.

### Textbooks

A course will be taught using an existing successful textbook. The text should be available in hard copy form to permit the student to annotate it as he studies. In some cases, the test can be supplemented with course notes where additions are necessary. These can be provided to the text author for inclusion in the next edition. In some cases, an OER textbook is available.

OER (Open Educational Resources) is a program that includes textbooks, course materials, online modules, videos, and assessments that support teaching and learning. “Open” means more than just free; it means that the resources carry an open copyright license, giving staff and students the freedom to modify, reuse and share them. Using openly licensed content also means that staff can legally modify material to tailor instruction to meet the needs of their students. In the US, the retail prices for recent editions of Fundamentals of Corporate Finance, Modern Physics and Principles of Microeconomics, textbooks that are required for big introductory courses, run to hundreds of dollars. This invention can use free textbooks when they are available and create them if necessary. Generally, the cost of a textbook is small compared with the cost of taking a course at a university. See Wikipedia Open Educational Resources.

Separately from the textbook, each nugget can have associated questions to be used on quizzes if there are not enough questions in the textbook. These quiz questions can be changed from time to time and new questions can be added. In addition, there will be questions used by SecureTest which are not available to the student and will be used by SecureTest to test the comprehension of students of the subject matter being studied. If a significant number of students have problems with one or more of these questions, the information will be used to improve the nugget description until the problems disappear. The nuggets can be consecutively numbered and chosen randomly at various stages in the testing process. Initial quizzes can be conducted shortly after the student has studied the material. Later SecureTest tests will contain questions from the nuggets randomly chosen over the full course that has already been taught.

http://achievingthedream.org/resources/initiatives/open-educational-resources-oer-degree-initiative Discusses an initiative to reduce the cost of higher education and is consistent with the teachings of this invention. It is known as the Open Educational Resources (OER) Degree Initiative.

This invention starts by picking an existing textbook.

The courses define up until now generally teach and test knowledge and information rather than the ability to express the students' thoughts through writing and speaking. This is mainly applicable to STEM courses. Colleges and universities, however, must also teach the ability to write and express thoughts in more detail than can be handled with multiple choice or other short answer questions. Some testing in this area can be accomplished by presenting paragraphs and asking the student to find grammatical errors, for example.

A student registers to take a course and acquires a headset (for example a SecureTest® device). The headset guides him through a complete course with lectures when available, homework, and very frequent tests. If he misses a question on a test, he is provided more instruction or told to study the appropriate nuggets until he gets a near perfect score on the test after which he can go forward, after completing a section, and take a SecureTest test. The headset prevents him from cheating on the SecureTest tests and the questions can be changed each time he takes a particular test. Once he passes the test, he can go on to the next section of the course. He can quit the course at any point and his grade can be based on how far he got through the course. If he completes the course, he gets an A. This concept is partially described in the book One World Schoolhouse by Salman Khan, although of course he did not know of the headset of this invention. A is the only grade for completing the course. Lower grades can be used for partial completion. Homework is just practice. It is not graded and thus there is no incentive to cheat. It can be graded for the student, but that grade does not affect the course grade.

Online courses can be dull, but so is a STEM education. Students must be motivated to complete a STEM education. It is not an objective of this invention to make courses entertaining. Schools can implement adjunct activities to try to stimulate students' interests. However, this is not part of the system discussed here. The lectures that can accompany the course can be examples and explanations that go beyond what is written in the textbook without adding new information. Animation, for example, can be supplied as can videos showing the applications of the principle being discussed. Additional explanations of this issue see https://academytoday.co.uk/Article/your-online-students-arent-paying-attention, or https://www.ecampusnews.com/files/2017/06/Student . . . which are incorporated by reference herein.

Many important tests are given in China under the control of the government and where the student must appear in person and cheating on tests is very difficult. In such cases, many schools exist for the purpose of teaching students so that they can do well on the government tests. In this case, the course material is held confidential from non-paying students, otherwise the schools could not survive. This makes online teaching very difficult in China as any student could experience the lectures if they are not protected. There is a need in China, therefore, for a system of online teaching where the security of the lecture material can be provided. This need is met through the headsets described here.

In the US, proctoring companies attempt to prevent cheating on tests. These companies have a similar sequence of the services provided: the proctor identifies the test-taker (using test-takers passport or any other documents); the proctor continues to observe the testing session (all sessions are video recorded, the desktop of the test-taker computer is also recorded); and the proctor checks the test-taker during the test (it can be made in a way of questioning the test-taker or audio signals that ring at certain times).

According to the presentation of Kryterion company: “ . . . . After the proctor verifies that your ID matches your image appearing on their web camera, they will ask you to answer a few security questions. These will further ensure that the correct person is taking the exam.”

So, basically, ‘cheating’ means receiving test answers while the proctor observes the verified test-taker sitting in front of the computer.

Cheating consists of two stages: interception of unique test questions and receiving answers to test questions. Receiving answers can be much easier for a cheating test-taker than intercepting information from a company that sent special tests to the examinee.

Online proctored testing (almost all the above-mentioned companies) allows test-takers to take and pass exams from their homes. This fact increases the possibility of cheating.

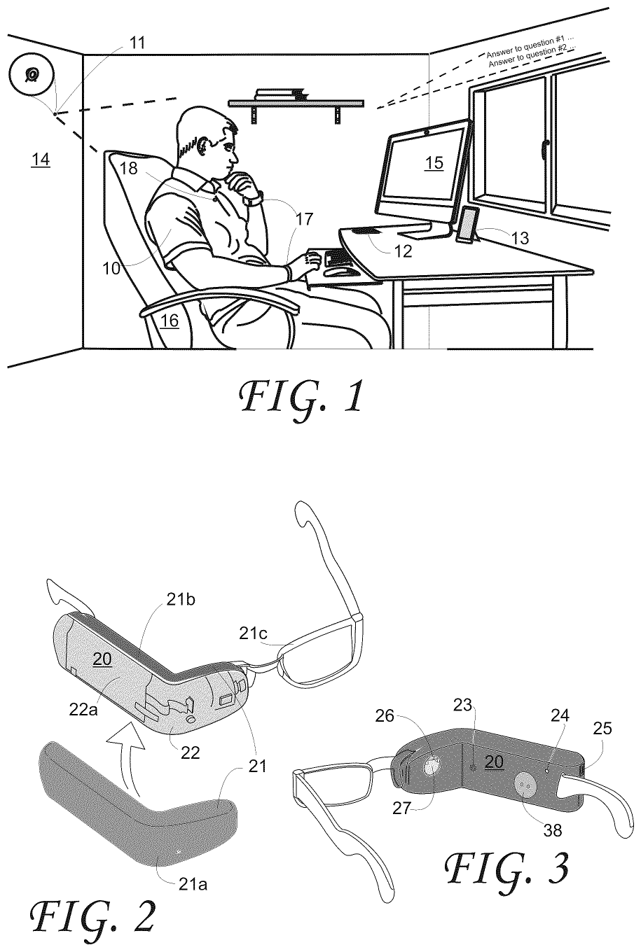

Receiving answers which won't be noticed by proctors can be done by the following ways: answers are provided on a tablet or a smartphone located behind (or near) the headset; projection of the answers to any surface (wall, screen, etc.) behind the headset as illustrated (FIG. 1); using a compact Morse code transmitter by touching the skin of the test-taker; a micro-earpiece located in the ear, vibrations in the seat, a bone speaker attached to the student's shoulder, head, or neck (or other bone) underneath clothes, etc.

Question interception can be achieved by hidden micro cameras (located in the wall or on the test-taker's clothes) which capture the headset screen with answer choices and send it to test-taker's consultant. Alternatively, it can be achieved by a transmitter which captures video signals from the system to the headset, and located in conjunction with headset wires, and then transmitted to the consultant.

One other significant problem in proctored tests given over the internet is that from time to time the connection to the internet is interrupted. When that occurs, the student is not permitted to complete taking a test and must reschedule it. This is an annoying occurrence and can delay the achievement of course credit by the student. There is a need, therefore, for a method of avoiding test disruption in the event of a disconnection from the internet.

To summarize test security, there are many ways that a consultant can obtain a copy of the questions on an examination and transmit the answers to the test taker that are not and cannot be detected by proctoring services. There are also other events that can interfere with normal proctored tests.

As generally used herein, a “test” is any type of question-based application that requires analysis by a person taking the test and a response from this person. A test may therefore be considered an examination, a quiz, an assessment, an evaluation, a trial and/or an analysis.

In China, there are no proctoring companies that prevent the viewing of lectures with the result that online teaching to become skilled to take the government tests does not exist. The lectures themselves are considered proprietary and should only be seen by paying students. There is a need, therefore, for a device which prevents unauthorized viewers from getting access to the lectures.

There are now thousands of courses available on MOOCs but meaningful credit cannot be given to a student taking such a course until the test security issue described above is solved. This has now been accomplished as reported in U.S. Pat. Nos. 9,959,777, 10,410,535, 10,540,907, 11,244,315, 10,678,958, and U.S. patent application Publ. Nos. 20200118456, 20200301150, and others assigned to the current assignee all of which are incorporated by reference herein.

This invention is therefore concerned with education methods which are applied in conjunction with previous test and lecture security inventions described in the patents and patent applications and others assigned to the assignee of this invention (as well as new security inventions disclosed herein).

### Administration and System Operation

An underlying concept of the present invention is that a student located anywhere in the world ought to be able to obtain a degree from any college or university or other institution, provided the student can prove that he or she has mastered the coursework associated with that degree. Proof often comes from the student passing a series of examinations. Since the student can be located anywhere in the world, it can be impractical for that student to travel to a particular place to take an examination.

A secondary concept of the present invention is to permit a school to deliver courses including examinations online to registered students in a manner such that non-registered students cannot get access to the course material.

A third concept of the present invention is to permit a student to continue taking a test or viewing a lecture during internet outages.

A fourth concept of the present invention is to permit a student to receive a degree without physically attending a school.

A fifth concept of the present invention is to allow education systems that account for the differences in abilities of students.

A sixth concept of the present invention is to allow education systems that account for the differences in the time availability of students to attend classes or take assessments.

A seventh concept of the present invention is to guarantee that the student has mastered the subject matter for any and all courses studied under the system of this invention.

Consider for example, the SAT test historically required for college entrance. Normally, the SAT must be taken at an approved location where test taking can be monitored by proctors. Cheating can still occur in that situation as has been vividly pointed out in recent cheating exposé's which dominated the news in 2019, where proctors gave out the test questions prior to the exam in one case and altered the exam answers in other cases. Using the system described herein, an SAT, GRE or similar test can be taken any place without concern that the student may be cheating. Thus, a student does not need to travel to an approved location, but can take the SAT from his home, or other convenient location, which can be anywhere in the world. Additionally, many colleges and universities as well as US-based companies require foreign-born applicants to pass an English proficiency test, the TOEFL. To minimize the cost of taking such a test, a student or other person can take this test anywhere with the full assurance that he or she did not cheat.

Hiring organizations do not always care where the person has acquired the expertise if they can be confident that the student has done so. As an employer, for example, a manager does not care as much whether a person graduated from Harvard or MIT as he/she does whether the prospective employee has mastered the coursework. On the other hand, having a degree listed on a person's resume can greatly affect the person's opportunities for employment throughout his or her lifetime. In the United States, however, colleges and universities have become unreasonably expensive, especially when consideration is given to the fact that for the most prestigious schools, the student usually is required to reside on or near the campus. This residency requirement has little to do with his or her mastery of physics, engineering or other scientific or non-scientific subjects, but handicaps an otherwise qualified student from job opportunities and lifetime earnings.

A student can typically learn the coursework on his or her own and in fact, studies have shown that for many students attending class is largely a waste of time. Over the Internet, a student can be exposed to the best teachers providing well constituted lectures, textbooks, and other coursework. If this is done with many students, the cost per student is minimal. What is needed, however, is a method of verifying that a student has mastered the subject matter through taking and passing examinations over the Internet or in a classroom, and without cheating and at minimal cost to the institution.

A further advantage of the secure test and lecture system described herein is that it permits the standardization of courses and tests. Thus, a student who chooses such standardized courses can study those courses from any college or university that meets the standard. A particular course, for example, may not be offered by a particular university during a particular semester and thus the student would be free to take that equivalent course from another college or university and since the tests would be standardized, the credits can be honored by any university where the student eventually wishes to obtain his or her degree. Thus, degrees become more portable and their acquisition more suitable to people who may live at various locations during the time of the college or university experience.

Furthermore, under the Paideia Services education system described herein, lectures are not necessary for mastering the subject matter and thus the course can be taken at any time and place.

An objective of the present invention is therefore to provide a system that can ascertain the identity of a test-taker with certainty and that cheating has not occurred during test-taking. Prior to discussing how these goals are achieved, an understanding of the cheating prevention process needs to begin with an analysis of the flow of information from the test-providing institution to the student's eyes. A similar analysis applies to the distribution of proprietary lectures.

For now, assume that the test is a multiple-choice test or one where the answer is in the form of a number. The institution can randomize the questions and answers of a test so that no student will take the same test with the same order of the questions or answers. Therefore, knowing the answers provided by one student cannot help another student. As a result, the answers which are sent back to the test-provider do not need to be encrypted, except where added security is desired that the answers have not been altered by the test-providing company or the college or university as explained herein.

The questions making up the test, however, do need to be encrypted and careful attention needs to be paid to where the decryption process occurs and to the protection of the private key which performs the decryption and the process by which it is generated. For example, if decryption occurs in an unprotected computer, then two problems arise. First, the decrypted test can be captured, and a copy sent to a computer in another room, for example, or the private key can be copied, and a second computer can simultaneously decrypt the test. Once the test can be viewed by a consultant who is not seen by a proctoring system, the consultant can transmit answers to the test-taker by a countless number of methods facilitating cheating.

Consider how the consultant might conduct this transmission to the test-taker. Perhaps, the consultant is in an adjoining room and transmits answers using RF communication to a device hidden on the body of the test-taker which retransmits to a receiver pressed against a part of the test-taker's shoulder or head, hidden by his or her hair or clothing, or mounted on his or her teeth. Such devices are readily available. RF frequencies used can be chosen to be undetectable by any device designed to detect such transmissions since the range of frequencies available span more than 6 orders of magnitude and, in addition, frequency hopping techniques can be used. An RF sensor mounted anywhere cannot pickup such transmissions without knowing the transmitted frequency and coding scheme.

Even if the consultant is in another country, if he or she can see the test, there is no way to prevent transmission of answers to the test-taker. Other methods include vibrators in the seat, wires attached to head-mounted speakers, etc. The consultant can even project the answers onto a portion of the room ceiling, walls or floor which is not covered by room monitoring cameras but observable by the test-taker and can even alternate such locations to fool systems that monitor the test-taker's behavior. Basically, there is no method of preventing the consultant from communicating answers to the test-taker and therefore, it is necessary to prevent the consultant from obtaining a copy of the test questions.

If the questions or lectures are decrypted on an ordinary computer, then many potential information leakage problems exist. Regardless of the operating system, if the consultant can obtain access to the processor board of the computer, then the connector that connects to the display can be removed and reconnected to a splitter inserted in such a manner that the display operation is unaffected, but a second set of wires are now available which contain the display information. These wires can be connected to a small processor which connects them to a transmitter to send the display information to another room by undetectable RF. Alternately, a simple wire can be used, hidden from view of whatever monitoring cameras are present.

Another approach is to steal the private key which cannot be protected in an arbitrary computer. Once the consultant has the key, he or she can intercept the transmissions to the computer and decode the test on a second computer. A conclusion is that the private key, and/or the code used to generate the key, must be stored and the decryption process undertaken in a special protected device discussed herein.

Consider now the display. If there is a display where the questions can be seen from anywhere other than the eyes of the test-taker, then there is another path for leakage of test questions. If decryption occurs right at the display, and the display is protected from tampering, the display itself can facilitate transmission of the test questions. A camera looking through an undetectable port in a wall, see FIG. 1, or undetectably worn by the test-taker, can capture the image of the test questions and transmit this to a consultant by any number of methods. Thus, either the display must be scrambled, so that only the test-taker wearing special glasses can see the questions, or the display must be so close to the test-taker's eyes that no one else can get close enough to see it. A conclusion is that no ordinary display or ordinary computer is usable without incurring a risk of cheating.

Some methods for accomplishing the objective of cheating prevention which have been considered include using one or more cameras to image a substantial portion of the space around the test-taker so that a consultant (or other person aiding the test-taker) cannot be in a position where he or she can influence the test-taker without being seen by a camera. A structure has been proposed such that the computer on which the test is being taken will not be accessible by another computer in another room, for example, where a consultant can simultaneously view the exam and communicate answers to the test-taker. If this structure is separated from the display and if the display is not scrambled or very close to the test-taker's eyes, this approach can be easily defeated. Also, it is not required that the consultant be where he or she can be observed by any cameras.

Similarly, it has been proposed that a microphone is preferably available to monitor the audio environment where test-taking is occurring to prevent audio communication with the test-taker by a consultant. A microphone will not pick up communications from the consultant in the form of RF communications translated into sound at the head, for example. The microphone will pick up any oral communications from the test-taker and thus it can be a necessary part of the system to detect if the test-taker is orally reading the questions to a consultant. To make sure that the microphone has been activated, a speaker or other sound source may be necessary to periodically create a sound which can be sensed by the microphone. Otherwise, the test-taker can cover the microphone or otherwise render it useless. An alternative or complementary approach, as described in the above-identified assignee patent publications, can make use of a contact microphone pressed against the skin or a facial bone, e.g., check bone, of the test-taker which will pick up sound emanating from the mouth of the test-taker but not be heard by the audio microphone. An audio microphone detects sound from the environment in addition to that from the test-taker. These sounds can drown out or otherwise prevent the microphone from picking up the test-taker from softly speaking into a hidden microphone that communicates with a remote consultant. These and other methods and apparatus show that it has become evident that the apparatus used to take the test or watch a lecture must be especially designed to solve the issues mentioned above.

The identity of the test-taker must be known and can be ascertained using one or more of a variety of biometric sensors and systems such as a palm, fingerprint, heartbeat shape, iris, retinal or other scan, a voiceprint, or a good image of the test-taker coupled with facial recognition software. For the purposes of the present invention, the primary nonlimiting biometric identification system will rely on the use of a small camera which has been designed to periodically image the test taker's iris, retina or portion of the student's face as discussed herein.

When taking a test, the student can go through a process which sets up the apparatus and validates its operation. The student can then confirm his/her identity which will have been previously established and stored locally or remotely for comparison. The process of ascertaining the identity can be recorded for later validation. Output from the various monitoring systems can be fed to one or more pattern recognition systems, such as trained neural networks, which have demonstrated high accuracy.

Each time the student takes one or more tests, or views a proprietary lecture, and thus demonstrates his or her mastery of the coursework (by passing), he or she can be awarded credits or one or more badges and after enough credits have been obtained, he or she can be awarded a degree. After the degree award, the student would then presumably begin working for a company, government agency, or other organization and the system should periodically be verified through consultations or surveys with the management of the organization to ascertain that the hiring organization is satisfied with the proficiency of the student derived from the online courses. This feedback allows for continuous improvement of the overall educational and testing process and system.

The degree-granting institution will incur costs during this process and some payment from the student to the institution may be considered. Depending on the circumstances, this payment can be a charge per course, per test, per credit, or per degree. Since the earning power of the student can be significantly increased, and out-of-pocket cost to the institution is small, these payments can be postponed until the student is being paid by a hiring organization and, in fact, such an organization may be willing to cover these payments. In any event, the payment should be relatively small when compared to the typical cost of a traditional college education. However, the degree-granting institution by this method can greatly expand the number of degrees granted and thus, although the payment per student will be small, the total sum earned by the institution can be substantial.

A good review of the state of higher education in the United States and of the rise of MOOCs can be found in the Nicholas Carr's article on the subject as published in the MIT technology review. The article can be found on the following Internet website. http://www.technologyreview.com/featuredstory/429376/the-crisis-in-higher-education/. Quoting from this article “Machine learning may, for instance, pave the way for an automated system to detect cheating in online classes, a challenge that is becoming more pressing as universities consider granting certificates or even credits to students who complete MOOCs.” It is an objective of this invention to respond to the mentioned challenge.

As discussed in numerous places in the literature, there is a significant difference in the complexity of evaluating a student's proficiency through tests which can be machine graded depending on the course subject matter. For those math and science courses where a numerical answer is to be derived, machine evaluation of the test is relatively simple. However, for those disciplines where a reasoning or writing skill or an artistic or mechanical skill is evaluated, there is great controversy as to whether this can be done by machine testing. This issue will be partially addressed here, although more research and innovation in this area is necessary.

A primary objective here is to provide confidence to the degree-granting institution that the student who is taking a test is in fact the student who has registered for the course and that the student is acting alone without the aid of a consultant who may be remote or nearby. This assurance should be provided with a probability of cheating reduced to on the order of one in 100,000 and, similarly, the false accusation that cheating is taking place reduced to a similar probability.

When a student decides to enroll in a degree program, for example, or even to enroll in a course for which he or she desires credit, the first step will generally be to register with the organization, typically a college or university, and to establish the beginning of the student's record. During this registration process, for the case where the student intends to get credit for one or more courses taken online, the student will be required to submit various types of information which will permit the student to be identified positively over the Internet. Although there may be little or no charge for taking the course, there will generally be some charges related to the test-taking, credit, certificate, or badge granting, and administration of the student's program. In a preferred embodiment of this invention, a specially configured device, a headset as described herein, will be loaned, or sold to the student to be used for test-taking.

In some applications, the course content is proprietary, and the tests are administrated by a government or licensing institution. In these cases, there will generally be a charge for the courses rather than or in addition to the tests.

When the student registers at a school, he or she will be generally required to submit a picture that will become part of his or her record. Later, when taking a test for the first time using the headset (the generic name for the test taking devices disclosed herein), another picture may be required so that the student can be properly associated with a headset having public key. A second picture of the student may be required on registration while wearing the headset. This is as a second check that the student in the school picture is the one wearing the headset. In fact, to assure maximum integrity, every person that registers with a college can be required to provide a picture which will be linked with his or her iris code and thus to his or her transcript. A student with the wrong iris code would then not have his transcript updated. Also, a prospective employer who receives a transcript can also take a picture which should match the person being hired. If the registration is done online, the laptop webcam can be used. If a student cheats by having a consultant take his or her tests, the transcript will not match the proper iris code and either the transcript will not be updated, or the transcript picture will not match the person.

Wearable glasses which meet the objects of this invention are described in the above identified assignee patent publications and are configured so that all the functions necessary to identify the student and significantly reduce the opportunity for cheating are incorporated within the glasses design or headset.

Since the value of a degree from a prestigious institution can be immense, the motivation to cheat when taking a test can be enormous. An industry of consultants now exists for aiding students in cheating when taking tests and thus obtaining a degree. This invention, where it is used, will prevent the success of such consultants, and thus assure the integrity of credits, badges, or an earned degree.

FIG. 1 illustrates a student 10 taking an examination using any one of various proctoring systems such as Examine or Proctor U. Student 10 can get help when answering examination questions if his/her consultant has access to these questions. This access can be accomplished in many ways such as through a hidden camera 11 which can be embedded in a wall 14 facing a computer screen 15 used for administering the test, hidden on the student 10 and looking through a hole in the student's shirt 18 or embedded in a piece of jewelry 17, or, most easily, a transmitter can be built into the computer which transmits the contents of the display to the consultant in another room or in another country via the Internet. The consultant can be a person who already knows the material being tested or he or she can query the internet for the answer.

For the case where the headset is used to receive lectures and other course material, the same methods can be used to transfer the course material to another student or to a recording device. For this reason, online courses cannot be given when the course material itself must be held confidential.

Since the consultant can see the questions, there are countless ways that answers can be communicated to the student 10 such as by projecting them on the floor, a wall or ceiling, placing a bone speaker in the student's seat 16 where it will contact the student's spine or on his/her shoulder under his/her clothes, for example. Even tying a string around the toe of the student 10 and pulling three times for answer ‘c’ can work. Broadcasting answers can be provided by smartphone 12 or tablet 13 behind the computer screen 15. None of these methods, and countless others, can generally be detected by an online proctor if the device is out of the proctor's view. It is thus not possible to prevent a consultant from communicating with the test-taker, leaving the only remedy left of preventing the consultant from knowing the test questions.

Of course, other methods are available such as bribing the proctor or someone that can provide a copy in advance of the test questions and answers. Prevention of these methods are discussed here. Since cheating is easily accomplished using all known proctoring or other anti-cheating methods, there is an urgent need for a system that cannot be defeated. Until that is available, granting meaningful credit for online education is not possible. Similarly, there is an urgent need for a secure method of teaching online when the course material is confidential.

A device constructed in accordance with the teachings of this invention is illustrated in FIGS. 2 and 3 which are perspective views of a head-worn glasses type device, generally referred to as a Headset 20, containing an electronics assembly (PCB) 22a with several sensors, cameras and a display all protected with a chassis intrusion detector 22 (CID) prepared using teachings herein.

FIGS. 2 and 3 are views from the front and rear respectively showing the device or headset 20 which comprises three main parts: plastic housing parts 21a and 21b (collectively referred to as a housing 21) and internal PCB parts covered by chassis intrusion detector 22 (CID). Housing part 21a serves as a cover. Housing part 21b extends from an eyeglass frame 21c. Housing part 21b can be substantially L-shaped with a first portion extending straight outward from an edge of the frame 21c and second portion substantially perpendicular to the first portion and positioned in front of the frame 21c. The frame 21c has a lens portion including an aperture for receiving an optional see-through lens (prescription or plain glass) and a support portion extending rearward from the lens portion. The support portion may be two temples as shown, or an elastic headband as described herein. Headset 20 includes a cross-view camera 23, microphone 24, and a contact microphone 38 (FIG. 3).

To further discourage cheating, if the test-providing institution is providing tests to 1000 test-takers either simultaneously or at different times, and if the test is of a multiple-choice type and contains fifty questions, the order of the questions and of the answer selections can be scrambled and thus different for each test provided. Since this provides a very large number of different tests each containing the same questions, there is little risk that answers from one set of questions can be of any timely value to a test-taker taking a different ordered set of the same questions.

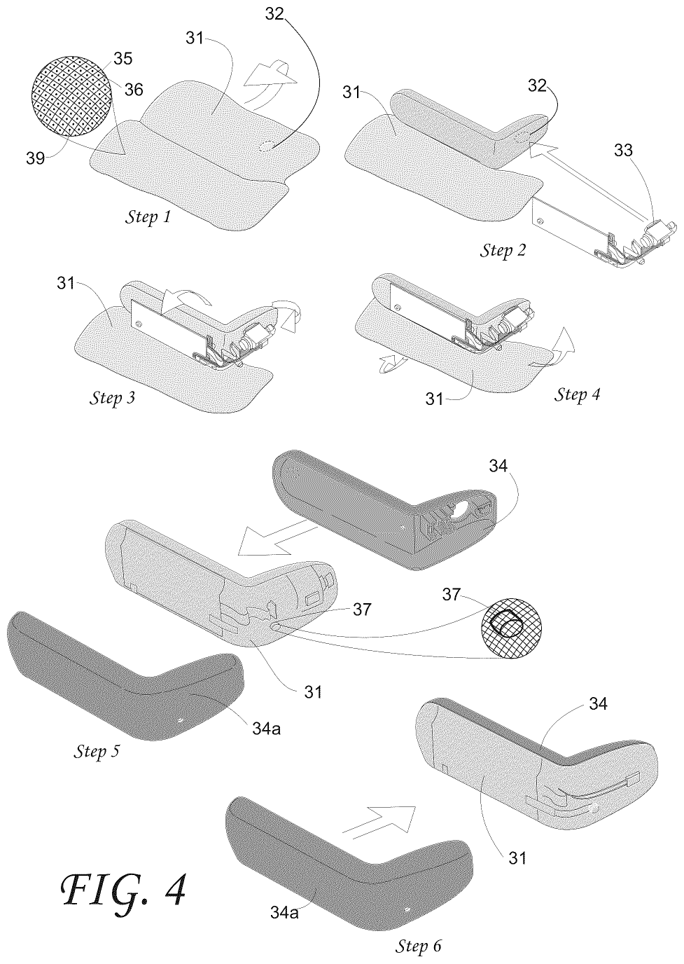

The entire electronics package of the device 20 (FIGS. 2 and 3) is encapsulated in a thin film 31 (FIG. 4) which is part of the CID 22. As described herein, an array of wires can be printed onto a plastic film encapsulating the electronics package, including the display and cameras, in housing 21 such that any attempt to break into the housing 21 will sever one or more of the wires.

The CID 22 can comprise a thin clear polyimide or other polymer film upon which is placed a thin copper or other conductor trace. In one implementation, the trace can be about 0.002 inches wide on about 0.010-inch centers. Thus, about 80% of the film is not covered by the conductor traces allowing for light to pass through. The thickness of the trace can be about 5 microns to about 25 microns. Indium tin oxide or even graphene can be used instead of copper.

The trace can begin and end at a pad each about 0.010 inch in diameter which can have metal on both sides of the film allowing for connections to the electronic circuits for the case where the CID 22 covers such circuits.

A private key, or the code for generating such a key, for decoding the test questions and any other commands sent by the test-providing institution can be held in volatile RAM memory in, for example, housing 21. This can be kept alive through an extended life (e.g., 10 years) battery which also can be recharged when the headset 20 is connected to a power supply (not shown) through connector 25. If the CID 22 detects an attempt to break into the housing 21, then power to the RAM memory can be shut off and the private key and any other private information or algorithms will be erased. Other techniques to disable the operability of the headset 20 for a test because of the detected attempt to break into the housing 21 are also possible, either alternative to, or additional to, the erasure of the private key.

When the test-taker is preparing to take a test, he or she will place the headset 20 onto his or her head. An image will be acquired of the iris, retina, or other biometrics by camera 26 and sent to a server via a secure telecommunications network and/or the Internet. The server will convert the iris image to a code and query the school's database to locate the student's record. The server can then associate and store the public key associated with the headset 20 with the student's ID. At the completion of this process, test questions will be transmitted to the headset 20 encrypted with the headset's public key, decrypted by the headset using the headset's private key and displayed on the display 27, for example, one at a time. An alternate method is to associate the public and private keys with the student rather than the headset. The iris check is then used to associate the student with the headset 20.

In the case of the cryptographic keys are associated with the student, the private key development algorithm can be held in the CID volatile ROM memory and placed thereon during headset manufacture after the CID 22 has covered the electronics, display, and sensors of the headset 20. This algorithm is erased if power is lost to the ROM or RAM memory such as will happen if a wire making up the CID 22 is cut as entry is attempted. The algorithm can comprise any of many functions which are known to those skilled in the art which can create a unique cryptographic key set based on an iris code or the headset ID in a manner which cannot be duplicated without knowledge of the algorithm. The algorithm is kept secure by the headset supplier and is only released in conjunction with the manufacture of a headset 22. Once on a headset 22, it cannot be retrieved and any attempt to do so will cause it to be erased. Thus, the key generation algorithm cannot be duplicated on any other device.

The iris camera 26 is controlled to periodically check to ascertain that the test-taker's iris or eyeball is present and that it has not changed. This is controlled by the processor on PCB 22a in headset 20. If anything anomalous occurs, such as the absence of an iris or eyeball or the change of position of the iris or eyeball, then the display 27 will be deactivated by the processor. Thus, when the test-taker removes the headset 20, the display 27 will automatically stop displaying test questions. Similarly, if the test-taker transfers the headset 20 to another person whose iris does not match that of the test-taker, then the display 27 will not show test questions. Above and in what follows, the iris will be used to represent any of the aforementioned biometric scans observable by camera 26.

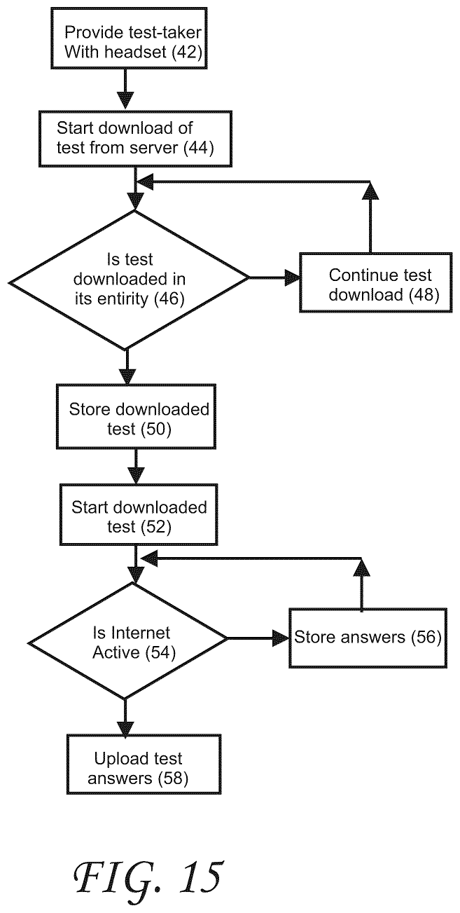

In an alternate implementation of the headset, protection is provided for failure of the internet (see FIG. 15). There are many examples of proctored examinations where the internet has been interrupted and the test terminated. In this case, the student usually has no option but to reschedule the test, which can cause great inconvenience. In this alternate implementation, the entire test is downloaded to the headset (step 42) and it is ensured that the test in its entirety is downloaded (step 44, 46, 48) and then once the test is downloaded in its entirety, the test is stored in a memory component in the headset (step 50). The student proceeds to initiate taking of the test, step 52, and answers the questions in the test which are presented in the display by the processor in the headset accessing the memory. Periodically, e.g., after each answer, it is determined whether the Internet connection is active in step 54 and if the internet is interrupted, the student can continue to answer the test questions even without the knowledge that the internet is no longer connected since the test answers can be stored in the memory of the headset in step 56. At the end of the test or when the internet connection is restored, the student can connect again and upload the answers to the questions (step 58). Thus, in contrast to proctored exams, internet interruptions do not affect the taking of a test.

In earlier versions of the headset, various security checks were done on the company server such as checks for typing using the front camera, the presence of hidden cameras using the cross-view camera and periodic iris checks and eyeball location checks using the iris cameras. In the version now being described, the iris checks are only done when the headset is first placed on the student's head after which the iris cameras are used to ascertain that the eyeballs are present. Such a check can be done sufficiently often, such as twice a second, such that the student cannot transfer the headset to another person. If the eyeballs are no longer present, the display 27 can be blanked requiring the student to revalidate his/her irises. If the iris validation is done on the server and if the connection to the internet has been lost, then the student will be forced to wait until the internet connection has been restored. Otherwise, the student can complete taking the test even if connection to the internet has been lost.

Under this design, it is even possible for the student to download multiple tests and then travel to where there is no internet coverage and complete multiple sections of multiple courses before returning to the internet. For this case, the iris checking, or other biometric, software would need to reside on the headset.

When the test-taker has completed answering the test questions, he or she can indicate such through the mouse, keyboard, orally, or gesture (user interface) and the display 27 will no longer display test questions. The remainder of the interaction with the test-providing facility can then occur as described herein.

A forward-looking camera can have a field of view (FOV) of about 120° or, alternatively, more than one camera each with a lesser FOV view can be provided. If more than one camera is used, a larger FOV even exceeding 180 degrees can be obtained. This FOV will cover the hands of the test-taker to check for the case where the test-taker is typing in the questions on a keyboard where they are transmitted to a consultant. If the hands of the test-taker cannot be seen by the forward-looking camera, the display 27 will be turned off until the hands can be seen. If this happens frequently, the test can be terminated. The forward-looking camera can also be used to check for the existence of other devices near the test-taker. These devices may include a tablet or other computer, a smart phone, books or papers, displays, or any other information source, including notes projected onto the ceiling, wall or floor, which is not permitted to be used for the particular test. If the test is an open book test, then use of some of the above-listed objects can be permitted. Software which accomplishes these pattern recognition tasks can utilize one or more trained neural networks.

The test-taker may have enabled a hidden switch which disconnects the keyboard when a keyboard is allowed, from the headset 20 and connects it to a consultant thereby enabling the test-taker to send test information to the consultant. The forward-looking camera can determine that the test-taker is typing, and the processor can ascertain that the headset 20 is not receiving the typed information and indicate a fault. For most tests, a keyboard will not be necessary and thus it can be eliminated from the setup to minimize its use for consultant communication. As described herein, a virtual keyboard can be provided when typing is required.

A limited number of encrypted commands which relate to the test being administered can be transmitted with the encrypted test from the test-providing institution or test administrating facility. These commands control some aspects of the test-taking process such as whether it is an open book or closed book examination, whether it is a timed test and if so, how much time is allowed, how many restarts are permitted, how many pauses are permitted etc. Since the test process is controlled by the headset 20, these commands will be decrypted and used to guide the test-taking process by the headset 20.

A schematic of the operation of the chassis intrusion detector 22 is provided in FIG. 4. Since the chassis intrusion detector 22 is designed to encompass the entire electronics and sensors assembly, it must be relatively thin so as not to interfere with the contact microphone 38, microphone 24 and speaker or sound creator 28 and be transparent such as to not interfere with the display 27 or camera 26. In some applications, not all of these devices are covered by the CID 22.

CID 22 (FIG. 2) is a thin film which wraps around the PCB 22a and other parts. It can be made from a single sheet folded over and then glued together. It must conform closely to the camera 26 and display lenses so as not to distort the images if it covers them. A wire to the USB connector 25 will be very thin where it goes through the CID 22. Connector 25 can snap into a holder built into housing 21.

A preferred construction, as illustrated in FIG. 4, is to provide a single film layer (film 31) comprising a labyrinth of wires 35, 36 which are very narrow and closely spaced such that any attempt to penetrate the film 31 will cause one or more of these wires 35, 36 to be cut. The base film 31 can be made from polyimide onto which is printed the electric wires 35, 36. The final assembly can be covered with a thin coating to insulate the wires 35, 36. A microprocessor (not shown) monitors the total resistance, inductance and/or mutual inductance of a circuit including the wires 35, 36 and erases the private information if there is a significant change in these measurements, e.g., above a threshold. Since any attempt to break into the electronic and sensor assembly will necessarily sever one of these wires 35, 36, this design provides an easily detectable method of determining an attempt to intrude into the system electronics and sensor assembly.

The CID 22 has following properties:
1. The wires 35, 36 can go along both sides of the film (FIG. 4). They can be run one way on one side and cross at right angles on the other side. Alternately, a wire can be printed only on one side of the film.
2. The wires 35, 36 on one side can be connected to those on the other side by plated through holes so that there can be one continuous circuit. Alternately, the wires can be arranged so that there are multiple circuits which can be connected in parallel to form more than one circuit each of which is separately monitored, or the total impedance of the separate branches can be added together, and the sum monitored. By this method, the total resistance of a branch can be kept within easily measurable bounds. Normally, the wire width is kept small so as not to interfere with the passage of light where the CID 22 covers displays and cameras. If the resistance gets too high, the wires can be made wider at locations where they do not cover cameras or displays. Additionally, the wires can be made from indium tin oxide which is transparent or graphene.
3. On the underside near the mating socket in the PCB 22a, the wires 35, 36 can get wider (˜200 microns) so that a 2-pin connector can be attached.
4. The CID 22 can have very small holes 39 (about 50 to about 100 microns diameter) located in the centers between the wires 35, 36, or alongside of wires when only one side has wires, to allow it to breathe to prevent the buildup of heat from the electronics.

The assembly procedure may comprise the following steps (FIG. 4):
Step 1: prepare to wrap film 31 constituting the CID 22 around PCB 22a.
Step 2: wrap CID 22 over the PCB 22a. A critical step here is the attachment of the CID 22 to a display lens 33. Circle 32 can be a marked location on the CID 22 opposite the position of display lens 33. Circle 32 can be glued to the display lens 33.
Steps 3, 4: after gluing the PCB assembly, plug the CID 22 into the PCB 22a and wrap the rest of CID 22. Now, the PCB 22a is fully covered by the film 31 to form the CID 22.
Step 5: insert PCB 22 in housing 34; forward looking camera 37 and cross view camera are covered by the film 31 of the CID 22.
Step 6: Snap housing part 34a (like housing part 21a) into the housing 34 (like housing part 21b).

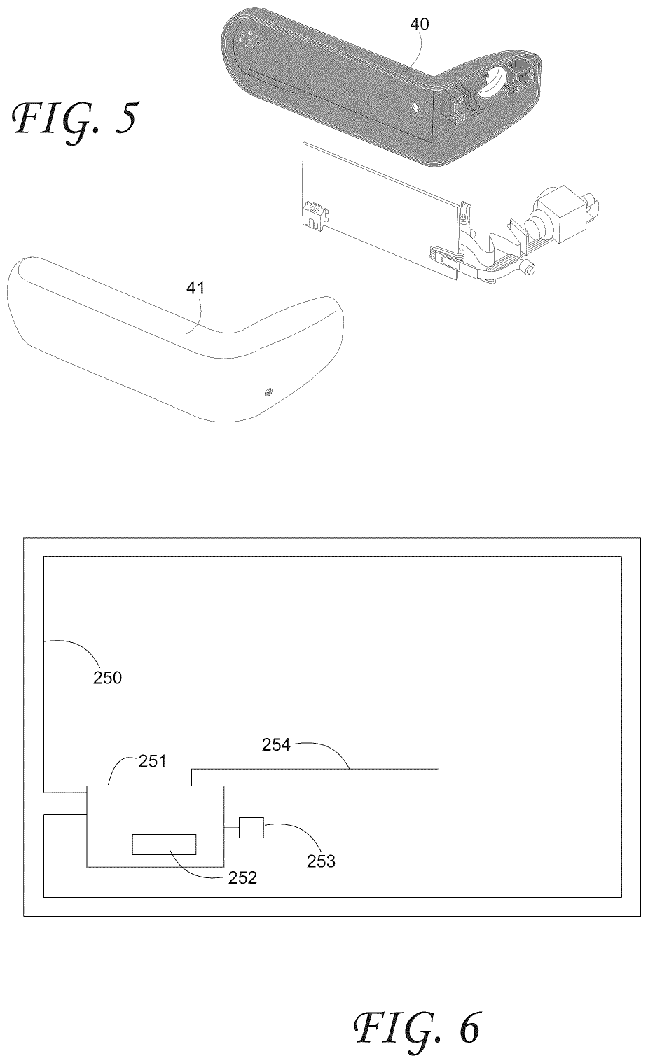

FIG. 5 shows the unassembled device housing: rear housing part 40 and front housing part 41 which are like housing parts 21b, 21a, respectively.

FIG. 6 illustrates that the chassis intrusion detector (CID) can contain its own microprocessor security assembly 251, containing the circuit property monitoring processor and battery 253, or they can be located on the PCB 22a. The CID 22 can also contain its own RAM memory 252. The RAM memory 252 can contain the private key and/or key generating code and other private information which is kept alive and thus usable by the battery 253. The battery 253 is chosen such that it can provide enough power to maintain the RAM memory 252 active for many years and provide power to the microprocessor security assembly 251 to monitor the wire labyrinth. The conductive wire is attached to the microprocessor which checks, for example, the resistance or impedance of the wire. Any change in resistance or impedance detected by the microprocessor is indicative of an attempt to intrude into the interior of the electronics and sensors assembly. If such intrusion is detected, power is removed from the RAM memory 252 and the private information is erased.

Power may be supplied from an external computer though connection 254 leading to the USB connector 25 of FIG. 3. Connection wire 254 also provides communication from the electronics and sensors assembly of which the security assembly is a part. The fine wire maze is shown at 250. Security assembly (SA) 251 can be a separate subassembly which is further protected by being potted with a material such that any attempt to obtain access to the wires connecting the battery 253 to the microprocessor and to the RAM memory 252 would be broken during such an attempt. This is a secondary precaution since penetration to the SA 251 should not be possible without destroying the private information.

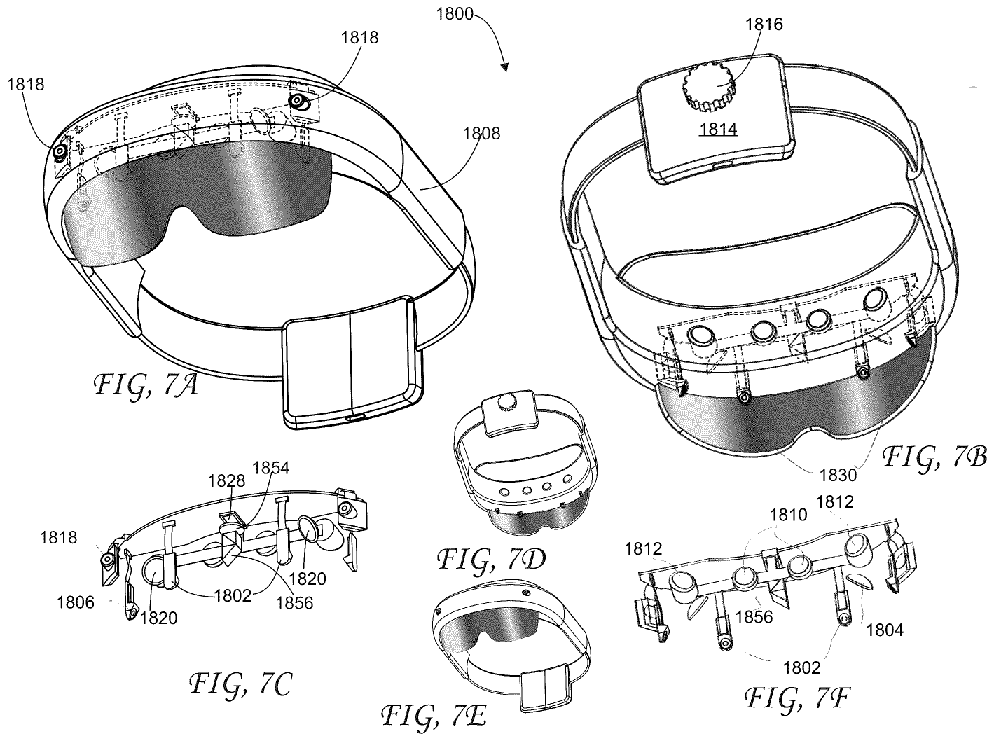

An alternate headset design which provides an image to both eyes using a single microdisplay is illustrated in FIGS. 7A-7F. In this design the components, which must be protected by the CID not shown, are more closely arranged to simplify the CID design. A single microdisplay 1828 is used to illuminate the lenses 1830 seen by each eye. Two iris cameras 1802, two crossview cameras 1806, and two forward cameras 1818 can be implemented in this design. Since the display will be seen by both eyes, both must be monitored to guarantee that the device has not been rotated or in some manner pulled away from either eye to permit a foreign camera to be inserted. Similarly, the crossview cameras 1806 must now watch both sides of the test-taker's head to search for nefarious cameras inserted by the test-taker.

Sensor assemblies 1810 and 1812 are provided on each side of the forehead (see FIG. 7F). These sensor assemblies 1810, 1812 measure the EKG and sound emitted by the test-taker's head. Sensor assembly 1810, for example, can contain a contact speaker and contact microphone, one in each sensor. Similarly, sensor assembly 1812 can contain an ECG (EKG) sensor. The contact microphone will determine when the test-taker is emitting sounds and the contact speaker will be used to test that the contact microphone is in contact with the test-taker's skin, as described in the previous headset examples. The contact speaker can also emit an audio sound and thus can be used to test the audio microphone, not shown, if present.

Since the EKG sensor pads must be sensitive to very low voltages, they generally will be placed on the outside of the CID. A small pair of contacts can be placed in the CID to permit signals to be passed from the EKG sensors to the interior electronics. Other methods of transferring information from outside the CID to inside are discussed herein. The EKG sensor pads can be appropriately attached to the CID by gluing in such a manner that any attempt to remove the EKG pads will destroy the CID. Two or more forward or front view cameras 1818 are provided in order to increase the field of view of the sensor system and to permit future 3D images to be created when augmented reality is implemented into this design. Although not shown, the optical system can be arranged such that alternately polarized frames can be fed to the right and left eyes of the test-taker wherein the single display panel can pass the information to the eyes to permit 3D holographic viewing by selectively polarizing successive frames or even in the same frame.

Additional biometric checks can be implemented using the forward-facing camera including fingerprints and palm vein prints.

The headset in this example contains a headband 1808 with an adjustment knob 1816 to permit the apparatus to the securely mounted to the test-taker's head (see FIG. 7B). As an alternate to the adjustment knob 1816, a ratchet arrangement can be provided which allows one side of the headband to be inserted into the other and pushed together until the proper fitting has been obtained. A battery 1814 can also be integrated with the device and placed at the rear of the device to balance the forces from the headset on the head of the test-taker. In this manner the center of gravity of the headset can be adjusted to be placed near the center of the test-taker's head. Under these circumstances there should be little tendency for the headset to slip forward or backward. The battery 1814 now can be considerably larger than in previous designs and designed to provide several hours of operation without an external power source. A wire, not shown, can lead from the battery to a wall charger or, alternately, a receptacle can be provided in the battery case for that purpose. With this long battery life, if the cause of the internet failing discussed above is a local power failure, the student can still complete his test or view his lecture despite the power outage. This is a significant improvement to proctored exams where a local power failure will require a restarting or rescheduling of the examination.

The display panel 1828 projects downward through lenses 1854 to a polarizing beamsplitter and mirror assembly 1856 which sends alternately polarized light to the left and to the right. Thus, the display image is split into two images alternately polarized. The birdbath mirrors 1820 then project the light down toward the lenses, or combiners, 1830 which contain reflecting surfaces and reflect the light into the eyes. Each lens can be differently polarized so that the light, which is polarized horizontally for the right eye, for example, interacts with a vertically polarized film on the right lens. This has the effect of making the right lens act as a mirror preventing the image from being seen from in front of the headset. Similarly, the polarized image for the left eye which can be polarized vertically, for example, would interact with a horizontally polarized film for the left eye. Rather than polarizing vertically and horizontally, naturally polarized light from the environment will have less effect if the polarization angles are +45 degrees and −45 degrees.

In an alternate arrangement, not shown, the light from the projectors will project to the rear of the device to locations on either side of the head where a mirror, such as a birdbath mirror would change the direction of the image and project it toward the polarized lenses for viewing by the test-taker. This method simplifies the design of the lenses eliminating the need for reflective surfaces to change the angle of the light to be integrated into the lenses.

Several adjustments which are not shown will now be described. An adjustment of the projector angles, or the mirrors that reflect the image to the lenses, can be used to accurately aim the reflections into the test-taker's eyes thereby accommodating any variance in the Inter pupil distance for different people. The lenses can be a compound lens arrangement whereby the outer lens corrects for prescription lens as needed for people with different requirements. The inner lens can be the one from which the reflections to the eyes are made. These two sets of lenses can be designed so that the outer lenses are interchangeable depending on the visual needs of the test-taker. The inner lens can be incorporated within the CID thus eliminating the possibility of a test-taker placing a camera that could see the inner lens and thus the display. The focus of the display can be changed by moving the various optical components. Under this arrangement the field of view can be controlled so that it can only be seen by the test-taker's eyes.

In this headset design, provision can be made for augmented reality devices such as a virtual smartphone, mouse or keyboard for use by the test-taker. These can require that the fingers of the test-taker be recognized and mapped in such a way that the motion of the fingers can be accurately tracked and understood. The virtual keyboard can be attached to a location near the test-taker's fingers or to a table that is either virtual or appears in the environment.

The arrangement in this design also lends itself to holographic presentations.

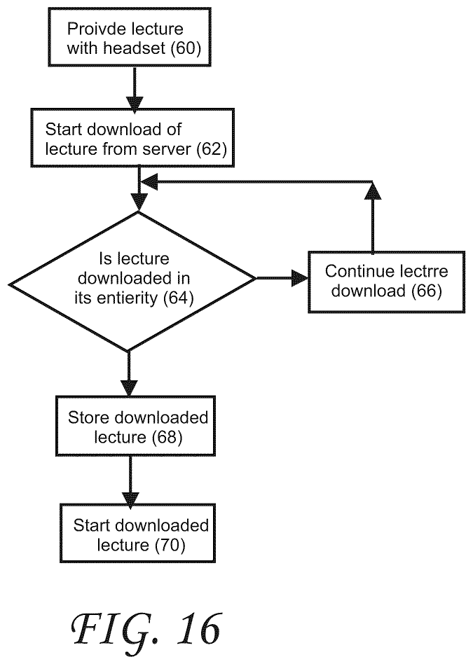

With reference to FIG. 16, the headset as in any of the embodiments disclosed herein or other comparably equipped headsets, may be used to deliver a lecture to a student by providing the student with the headset (having structure to provide audio and/or video of the lecture and a memory component that stores the lecture) in step 60, starting downloading of one or more lectures to the headset using a telecommunications link and a telecommunications device on the headset in step 62, determining whether the lecture is downloaded in its entirety in step 64 and if not, continuing the downloading of the lecture in step 66. Once it is determined in step 64 that the lecture has been downloaded in its entirety (which may be determined by using conventional techniques to ensure complete download of media), the method entails storing each downloaded lecture in the memory of the headset in step 68. Each lecture is caused to start from memory, when desired by the student, using a processor on the headset in step 70 which causes audio and/or video generation using the conveyance device of the headset only after the entire lecture is downloaded and stored in the memory of the headset. Since the entire lecture is downloaded and stored before it begins, a disruption in the telecommunications link after the entire lecture is downloaded does not affect the audio and/or video generation. The student is a person that is on the receiving side of a lecture being given by a lecturer.

To experience the lecture means that the intended student can view content of the lecture if any as well as hear content of the lecture if any. Usually, a lecture will have both an audio component and a video component, but the invention is suitable even for a lecture with only an audio component and a lecture with only a video component.

There are at least three modes of operation for lecture-viewing using any of the headsets disclosed herein. The first is when the lecture is downloaded in its entirety before the student can view it (depicted in FIG. 16). The second is when the lecture is not downloaded at all but viewed live. The third is when the lecture is simultaneously viewed while it is being downloaded. The latter two may have issues with interruptions in the Internet but not the first.

Biometric identification is essential to ensure that only the person supposed to experience the lecture experiences the lecture, e.g., a paying student. To this end, biometric identification protocol may be performed to limit experiencing of the lecture to only an intended student using a biometric identification system (whether entirely on the headset or only partly on the headset and partly on a server or other device at a remote location separate and apart from the headset) to check whether the student is the intended student for the downloaded lecture. The audio and/or video generation of the lecture may and should be stopped when the biometric identification protocol indicates that the student is not the intended student or no longer wearing the headset. The biometric identification protocol can be performed using a system on the headset, e.g., a check of the iris of the student using an iris camera on the headset which occurs when the headset is first placed onto the student and periodically throughout the duration of the lecture.

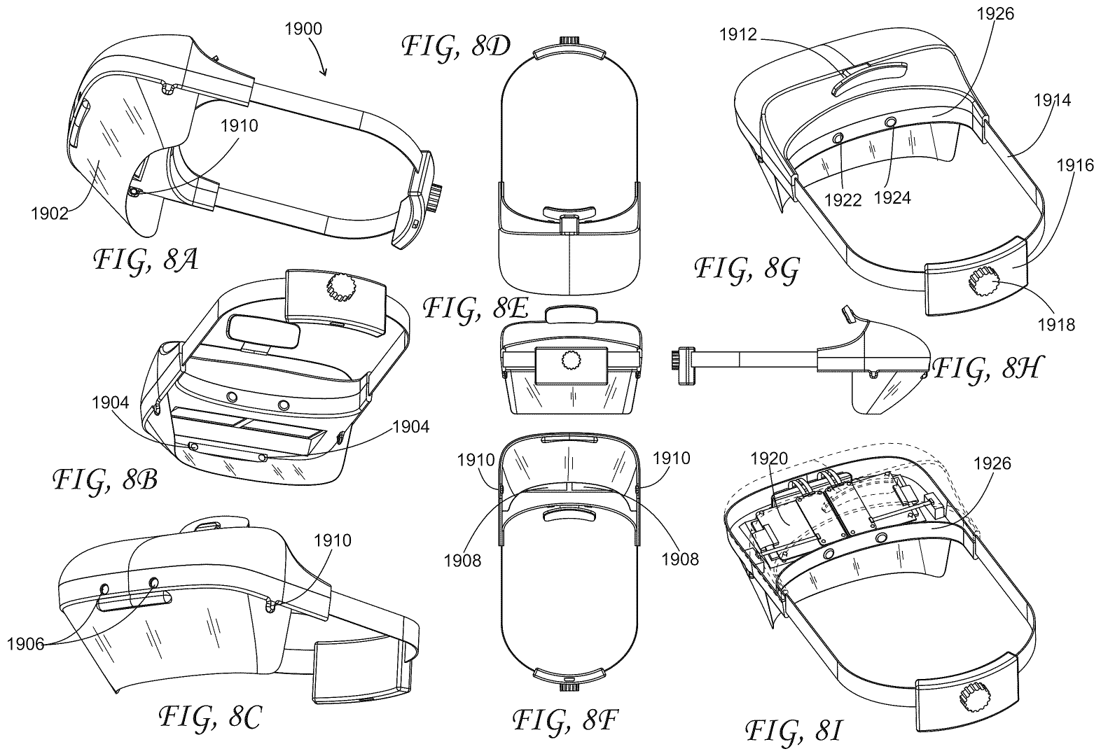

FIGS. 8A-8I illustrate another preferred design of a headset 1900 for two eyes, in this case utilizing two larger displays 1908 forming a display section in a housing of the headset 1900. Two displays 1908 are positioned approximately horizontally in the headset 1900 alongside one another as shown in FIG. 8F. Images from the displays 1908 reflect off one or more combiner 1902. Each combiner 1902 preferably has a semi-reflective coating on the inside surface, i.e., that surface in the optical path between the display 1908 and the eyes of the test-taker, which reflects only a percentage, for example 50%, of the incident light from the displays 1908 toward the test-taker's eyes. The balance of the light is passed vertically downward.

Each combiner 1902 allows the test-taker to simultaneously view the environment, since the combiner 1902 is positioned on the frame or housing of the headset 1900 to be in front of the test-taker's eyes when the headset 1900 is on the test-taker's head, as well as the reflection from the displays 1908. The combiner 1902 therefore does not block out all the light from the environment in front of the test-taker, in contrast to some virtual reality goggles that entirely cover the eyes of the wearer and prevent the wearer from seeing outside of the device. Also, the combiner 1902 does not have to contact or conform to the shape of the wearer's face at the bottom edge and so there is often a gap between the bottom edge of the combiner 1902 and the person's face.

A single display version of the headset has also been developed and functions basically the same as the two display version described herein.

The combiner 1902 preferably generally has an antireflective coating on the outside surface to potentially allow the maximum light to pass through the combiner 1902 from the environment. The combiner 1902 can also have a privacy film which prevents light from being seen from outside except in a direction approximately perpendicular to the surface of the combiner 1902. Such a film thus blocks the light which normally passes through the combiner 1902 in the vertical direction and could thus otherwise be seen from below. The combiner 1902 represents a singular combiner or multiple combiners that cooperate to provide the functionality described above. An upper edge region of the combiner 1902 is attached to the frame or housing of the headset 1900 so that the combiner 1902 is below the frame. Also, the combiner 1902 and frame or housing are components of a front portion of the headset 1900. The edges of the front portion are not configured to conform to the face of a wearer. In addition to a front portion designed to be at least partly in front of the eyes of the test-taker when the headset 1900 is on the test-taker's head, the combiner 1902 may also be provided with side sections, one on each side of the front section. As such, the person can see in front of them or to the sides only through the combiner 1902 and its associated structure.

The displays 1908 themselves can also have privacy films attached to their surfaces to accurately direct the light in a direction perpendicular to the display surface making it difficult to see the display from below. Privacy films generally work best in preventing light transmission in horizontal or vertical directions and therefore two such films may be required for the displays 1908. The combiner 1902 can also comprise a film of electrochromic or liquid crystal material whose transmissivity can be electrically controlled. Thus, the amount of light passing through the combiner 1902 from the environment can thus be controlled. This permits the view of the reflected image from the combiners 1902 under conditions of bright ambient light. Alternates to electrochromic and liquid crystal materials include Kerr cells. Finally, as discussed herein, the crossview cameras 1910 are provided to monitor the space surrounding and below the combiner to search for unwanted cameras.

Two iris cameras 1904 are provided to monitor the irises of the test-taker or lecture viewer and to make sure that the eyes of the test-taker or lecture viewer are in the proper position during test-taking or lecture viewing while the display is illuminated, and the headset 1900 is on the test-taker's or viewer's head. The cameras 1904 are also used for biometric identification purposes. The iris cameras 1904 can have a much wider field of view (FOV) than necessary to observe the iris and thus they can also be used to monitor for hidden cameras placed by a test-taker or viewer to transfer the contents of the screen to an accomplice. The iris cameras 1904 can have associated infrared (IR) or white light LEDs to illuminate the irises. White light LEDs can be annoying to the viewer and IR LEDs, if intense, can potentially cause eye damage. The displays, on the other hand, can provide sufficient light, especially when a white display is shown, to adequately illuminate the irises for identification purposes or at least for monitoring the location of the eyeballs.

Iris cameras 1904 are part of an iris camera system arranged on the frame of the headset 1900 and which is generally configured to image the left and right eyes of the viewer when the headset 1900 is on the viewer's head. The iris camera system may include a different number of iris cameras 1904, so long as the left and right eyes are imaged. The iris camera system is arranged on the front portion of the headset 1900.

Crossview cameras 1910 are provided to monitor the volume between the displays, combiner and eyes of the viewer to check for the placement of hidden cameras intended to transfer the contents of the display to an accomplice. Using the iris and crossview cameras 1904, 1910, it should not be possible to hide an imaging device within the volume encompassed by the headset 1900 and the face of the viewer.

Crossview cameras 1910 are part of a crossview camera system arranged on the frame of the headset 1900 and which is generally configured to image from a location on a first lateral side of the frame toward a second lateral side of the frame opposite the first lateral side and below the combiner, and image from a location on the second lateral side of the frame toward the first lateral side of the frame and below the combiner when the headset 1900 is on the viewer's head. The crossview camera system may include a different number of crossview cameras 1910, so long as the volume encompassed by the headset 1900 and the face of the test-taker is imaged. The crossview camera system is arranged on the front portion of the headset 1900. The word viewer is used herein to represent either the test-taker or the lecture viewer.

Two or more forward-looking cameras 1906 are also provided for monitoring the environment surrounding the headset 1900 and viewer. These cameras 1906, which together will encompass a large field of view, can be used to monitor for the existence of notes, textbooks, or other apparatus which could aid the test-taker in answering the test questions, but which are prohibited by the rules of the test. The existence of a computer which the test-taker could use to access the Internet can be determined. Similarly, if the test-taker is typing on a keyboard, that action can be detected. In short, the forward-looking cameras 1906 can detect any forbidden activity undertaken by the test-taker. They can also determine the presence of potential accomplices trying to help the test-taker during the test-taking process. The forward cameras 1906 can be provided with LED or other illumination which can be in the visual or infrared (IR) portion, or both, of the electromagnetic spectrum. The cameras 1906 need to be sensitive to IR if IR illumination is used.

Forward-looking cameras 1906 are part of a forward-looking camera system arranged on the frame of the headset 1900 and which is generally configured to image an area in front of the frame, and ideally to the outward sides of the frame when the headset 1900 is on the test-taker's head. The forward-looking camera system may include a different number of forward-looking cameras 1906, so long as the environment around the headset 1900 is imaged. The forward-looking camera system is arranged on the front portion of the headset 1900.

The images obtained by the six cameras discussed above can be analyzed using trained neural networks or Deep Learning technology, for example.

The headset is held in position on the test-taker's head by means of forehead resting pad 1912 coupled with a band 1914 which is adjustable for tension by adjustment knob 1918 or by a ratcheting system discussed above. Another band 1926, which holds the contact microphone 1922 and contact speaker 1924 in position against the forehead of the test-taker, also contributes to the proper positioning of the headset on the head of the test-taker. Multiple contact microphones and/or contact speakers as well as audio devices can be placed at other locations of the headset.

The electronic printed circuit boards are illustrated generally at 1920 and are powered by a battery 1916 through wires which are not illustrated or through connection to a wall or other power source.

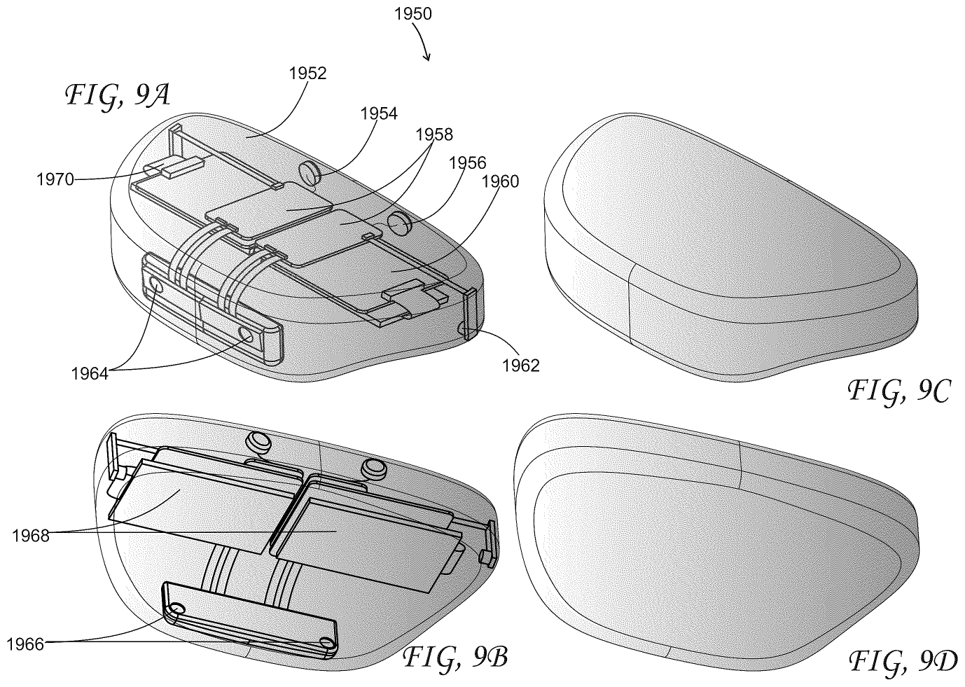

FIGS. 9A-9D illustrate key components of the device when covered with the chassis intrusion detector (CID). The operation of the CID is discussed in detail elsewhere, including in applications incorporated by reference herein, and will not be repeated here. The assembly covered by the CID is shown generally at 1950.

In FIGS. 9A-9D, 1952 represents the CID, 1954 is a contact microphone and 1956 is a contact speaker, 1958 represents interfaces between forward cameras 1964 and iris cameras 1966 with a PC board 1960, and 1962 represents the cross-view cameras 1968 represents displays connected to the PCB board 1960 by ribbon cables 1970.

The CID 1952 is represented by a smooth envelope. In practice, the CID 1952 will adhere to the surfaces of the various components. In some cases, it will be necessary to add additional structure to position the CID 1952 properly relative to the various components it is meant to protect. The CID 1952 may be attached directly to one or more of the cameras 1962, 1964, 1966 and displays 1968 in such a way as to provide a smooth surface that does not distort the images being acquired or displayed by these devices. Naturally, other configurations are possible whereby the CID 1952 adheres more closely to the PCB 1960 and some of the components such as a contact microphone 1956, speaker 1954, and various cameras 1962, 1964, 1966 are outside of the CID 1952. In this case, the passthroughs of the various wires become a concern.

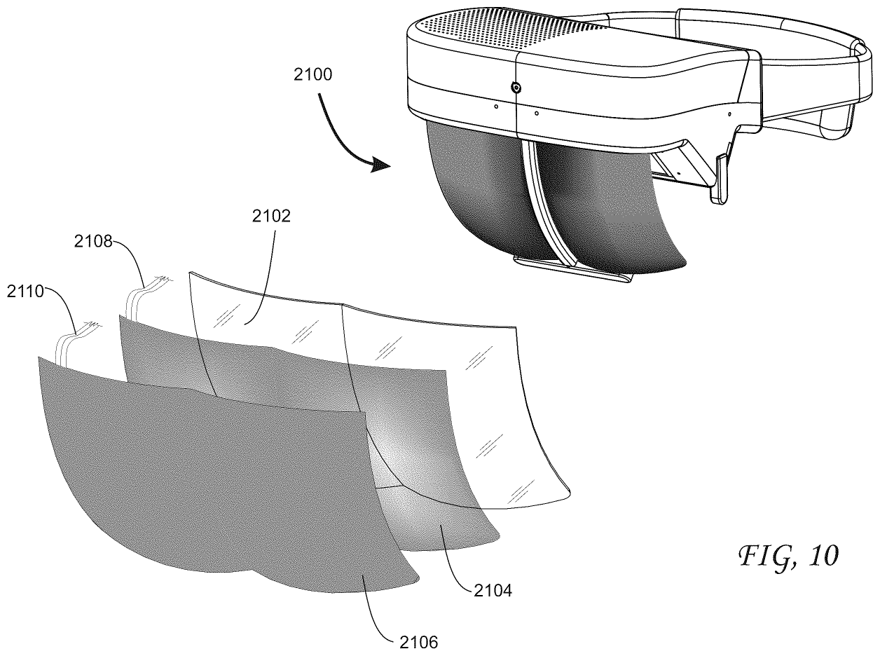

FIG. 10 illustrates another implementation of the headset in accordance with the invention using a combiner assembly shown generally at 2100. The combiner assembly 2100 can comprise two portions, one associated with each eye, and with each combiner section including at least 3 layers. The combiner portions may be integral with and horizontally alongside one another. The combiner assembly 2100 has lateral edges spaced apart from respective lateral sides of the frame of the device to form gaps between the combiner assembly 2100 and the frame alongside the eyes of the person when the frame is on the person's head. Naturally these gaps can be covered to prevent view of the combiner from outside.

Each combiner portion has a multi-layered or multi-film construction, which may be the same for both or different.

Preferably, an inwardmost layer 2102 is a reflective lens which reflects light from the display(s) to the eyes of the test-taker, also referred to as a display assembly. The reflective lens only partly reflects the images to be displayed (and to be viewed) by the person wearing the device. Intermediate layer 2104 can be an electrochromic or liquid crystal light control layer which controls transmission of light through the combiner assembly 2100. This can be called a blocking film. In the case of the liquid crystal implementation, the amount of light allowed to pass through the layer 2104 can vary from near 0% to about 50%. When it is electrically set at about 50%, the wearer, whether a test-taker or otherwise, can see the environment in front which is useful for augmented reality applications. However, anyone standing in front of the wearer can also see what is displayed on the combiner assembly 2100 and thus the test questions when the wearer is in a test-taking mode. The writing will be reversed so the observer will need a mirror to be able to read the text or it can be captured by a camera and processed by a computer. For the test-taking mode, therefore, the transmissivity can be set to near 0% blocking the transmission of the test questions through the combiner assembly 2100.

The liquid crystal implementation of the blocking film is commonly used in glasses designed for viewing 3D TV. See for example https://www.amazon.com/gp/product/B0833W9QQJ/ref=ppx_yo_dt_b_asin_title_008_s00?ie=UTF8&ps c=1. In this case, the right and left lenses, also referred to as display portions of the display assembly, are alternately turned into a blocking and non-blocking modes synchronized with a signal emitted from a specially designed TV. The electrochromic implementation is described in U.S. Pat. No. 10,359,647 (Vasiliev) discussed above.

If access to the blocking film, intermediate layer 2104, is accessible, a portion of the blocking film can be removed opening a window in the blocking film for the placement of a camera, for example, to capture the test questions. To eliminate this possibility, the blocking film can be covered with a CID 2106, an outward most layer, the nature of which is discussed herein. The blocking film and the CID 2106 can be connected to the electronics PCB (processor in the frame) which is done by, for example, wires shown generally at 2108 and 2110. The wires 2108, 2110 used can be in the form of flex circuits as discussed herein. This processor controls the content of the display assembly and can direct the blocking film to alternately block the two combiner sections or more generally control light transmission provided by the blocking film. The same processor could also detect attempts to access the blocking film and affect functionality of the combiner assembly 2100 or device when an attempt to access the blocking film is detected.

One or two cameras, not shown, can be used to monitor the blocking film to make sure that it has not been disabled. When blocking is on, for example during test-taking, the blocking film, i.e., intermediate layer 2104, should be opaque. This can be seen by camera(s) placed above or alongside of the display(s) facing the combiner assembly 2100. The display assembly can momentarily display a coded image which can then been seen by the camera(s) and a comparison made. If the test fails, the display can be turned off. The crossview cameras described above can also perform this function.

The CID 2106 can also be used in other modes such as to cover a keyboard or mouse making them unhackable.

The blocking film, i.e., intermediate layer 2104, can also be extended beyond the combiner assembly 2100 to block visual access to other paths where light from the display(s) could leak.

The liquid crystal version of the blocking film, i.e., intermediate layer 2104, can be switched in a small fraction of a second and thus by controlling the ratio of on-to-off time, it can be used to dim the light coming from the environment as a sort of sunglasses. An ambient light sensor can be added to control the amount of dimming.

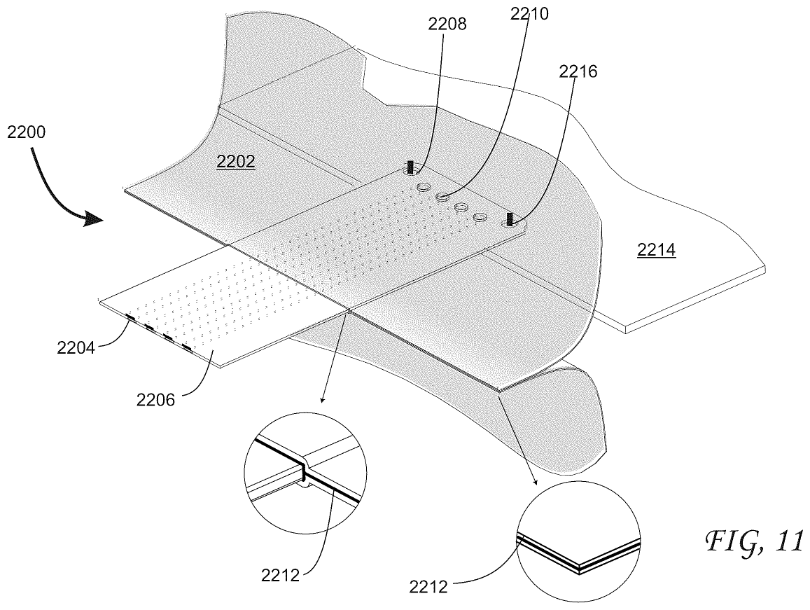

A flex ribbon circuit is illustrated passing through a CID joint generally at 2200 in FIG. 11. Ribbon 2206 of this flex ribbon circuit can be less than 10 mm wide, about 130 microns thick with, for example, about 18-micron thick by about 1 mm wide conductors 2204 sandwiched between two layers of polyimide, or other suitable film, with appropriate adhesive layers. The ribbons of the flex circuit 2206 can be bonded using adhesive 2212 to the CID layers 2202. The conductors terminate at solder pads 2210. During assembly, the flex circuit is placed over pins 2208, 2216 in printed circuit board 2214 where the solder pads on the flex circuit line up with solder pads 2210 on the printed circuit board, not shown. Heat is then applied with an air gun, for example, and the solder pads 2210 melt and attach to each other making the appropriate connections to the printed circuit board 2214. After all the flex circuits are attached to the PCB 2214, the edges of the CID layers 2202 are bonded together and to the flex circuits 2206. When the process is completed, it will not be possible to penetrate the CID without breaking one or more wires in the CID which then erases the contents of the RAM.

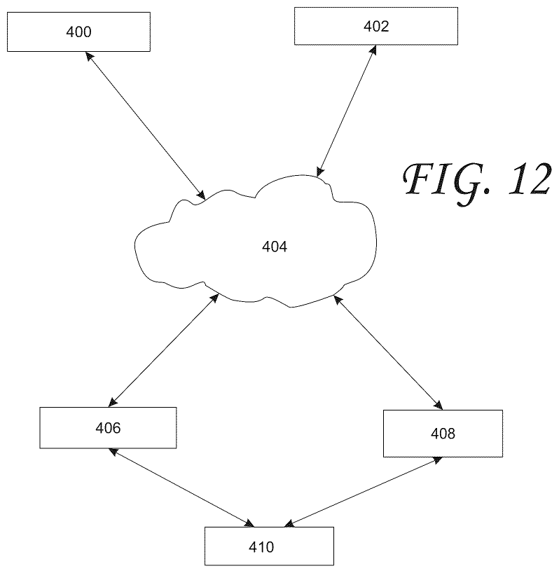

A system block diagram is shown in FIG. 12 and comprises a server 400, a Test-Provider or test-providing institution or test-administrating institution 402, a communications network 404, one or more headsets or devices 406, a computer 408 and the user 410.

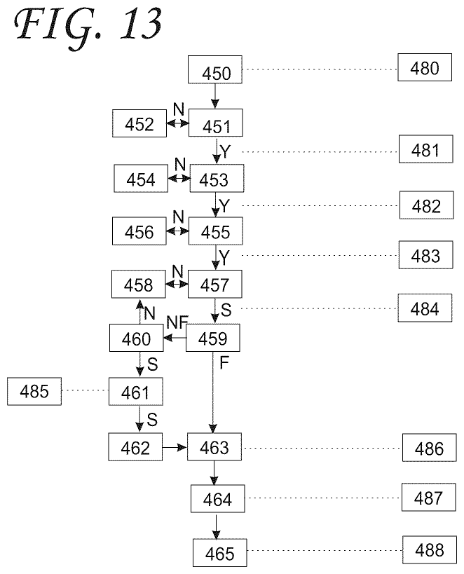

An administrator flow chart is illustrated in FIG. 13 and can comprise the following steps, not all are required, and others can be added:

| | |
|---|---|
| 450 | User plugs in headset |
| 451 | Mouse connects. |
| 452 | Mouse setup |
| 453 | Wi-Fi connects. |
| 454 | Wi-Fi setup |
| 455 | Iris scan |
| 456 | Wait |
| 457 | Web call |
| 458 | Troubleshoot |
| 459 | Get name |
| 460 | Web call |
| 461 | Send iris digital image and Headset/Device ID |
| | Server returns server public key using Headset public key |
| | Headset/Device sends public key to server |
| 462 | Iris, Headset/Device codes and public key linked with user |
| 463 | Test-taker authenticated |
| 464 | Choose test to take |
| 465 | Proceed to test-taking sequence |
| 480 | Display “Power is on” |
| 481 | Display “Mouse connected” |
| 482 | Display “Wi-Fi connected” |
| 483 | Display “Iris scanned” |
| 484 | Display “web call successful” |
| 486 | Display “Welcome Ann Smith” |
| 487 | Display list of user's available tests |
| 488 | End of login sequence |

In 464 the student can choose which test to take from a list that comprises tests from different courses. The courses can be supplied by different schools as explained below.

When this is accomplished, a signal can be sent to the server indicating that the test-taker is ready to take the examination.

The proposed running sequence is as follows:
1. A test-taker places the Headset 20 on his or her head, establishes a WiFi or cellular connection and, using the mouse, initiates the acquisition of his/her iris image.
2. The iris image is transferred to the test management and supplying server, hereinafter called the Secure Test server, where it is used to create the iris code using standard software.
3. If this is the first initiation, the test-taker enters his university student ID which is sent to the SecureTest or equivalent server.
4. The iris code is checked against the school database to confirm that the student is registered. If the student is registered but has not registered his/her iris code, then the code is registered.
5. The cryptographic key set associated with the Headset is used for communications.
6. Headset 20 sends the Headset ID, the student ID and public key (which can be the same as the Headset ID) to the Secure Test server.
7. The SecureTest server validates that this is a registered student.
8. Later, for software updates, new software can be loaded over Wi-Fi or another network from the SecureTest server whenever desired using the Headset's public key: Once the sequence above is completed, the SecureTest server sends a code indicating that a software update will follow.

What is generally not realized is that teachers and administrators play a significant role in cheating. Alleged cheating behaviors include the following and how it is avoided using the Headset based test system described herein:
1. Changing test-takers' answers after the test. When the test is completed, the answers can be first encrypted using the Secure Test public key and then again using the school's public key. The SecureTest server will generally grade the test and forward the test grade to the school. If there is any doubt as to whether the answers were changed, the two encrypted copies of the test answers can be compared. Alternatively, they can be routinely compared to check for cheating.
2. Teaching to the test. A significant number of potential test questions can be generated based on the subject matter to be tested. When a particular test is to be given to a class, questions can be chosen at random from this much larger list. Therefore, the teacher cannot teach to the test since no one will know ahead of time what questions will be on the test.
3. Illegal coaching during a test. Since each test-taker taking the test will have a different test and conversation between the test-taker and any other person will be captured, it is not possible to coach the test-taker during the test.
4. Using live exams as practice exams. Generally, the instructor should not know what the test questions will be and therefore they cannot be used as practice exams.
5. Reading off answers during a test. Since the instructor will not know the test questions and each test-taker will have the questions presented in a different order, also since any audio conversation can be monitored and recorded, it is not possible to read off the answers to the test during the test period.
6. Providing extra time for tests where there is a time limit. This can be made part of the control system of the Headset. In other words, each test will be allowed a certain amount of time. Extra time therefore cannot be allocated without that fact being known.
7. Disallowing low-achieving students from testing. A low achieving student will not be able to get credit for the course unless he or she has successfully passed various examinations.

Generally, the tests administered by the headset will be closed book tests in which case the forward-looking camera should not see any books, notes, laptop computers, cell phones etc. that could be used by the test-taker to get the help of a consultant. In a later implementation of the headset described herein, limited access to the Internet can be allowed using the headset. For that situation the headset will have a very large display including multiple screens and access to a particular website, for example, can be provided and the information that is on that website can be controlled such as to include all the relevant information needed to answer a test question without simultaneously giving access to a consultant. The student can be permitted to add notes and other information to the website.

If cheating is detected while a test-taker is taking a test, the test-taker can be warned that cheating has been detected and that if it is not stopped the test will be terminated. In the rare case where the test was terminated due to an error in the cheating detection algorithms, the test-taker can be given the opportunity to retake the test which can involve questions in a different order and even different questions.

Note that the headset's private key is never transferred off the Headset. Thus, if the encrypted test is intercepted it cannot be decrypted.

In some implementations of the invention, the headset can be the vehicle where students learn as well as take tests. Alternately, the learning phase can be done using any computer since the information need not be secure. The headset or the computer can facilitate reading and marking of text, viewing lectures or books, augmented reality, and maybe even virtual reality.

With the internet becoming ubiquitous (as in 5G), the Headset or any computer can be used for delivering lectures, textbooks and other course information with the headset only used for taking tests.

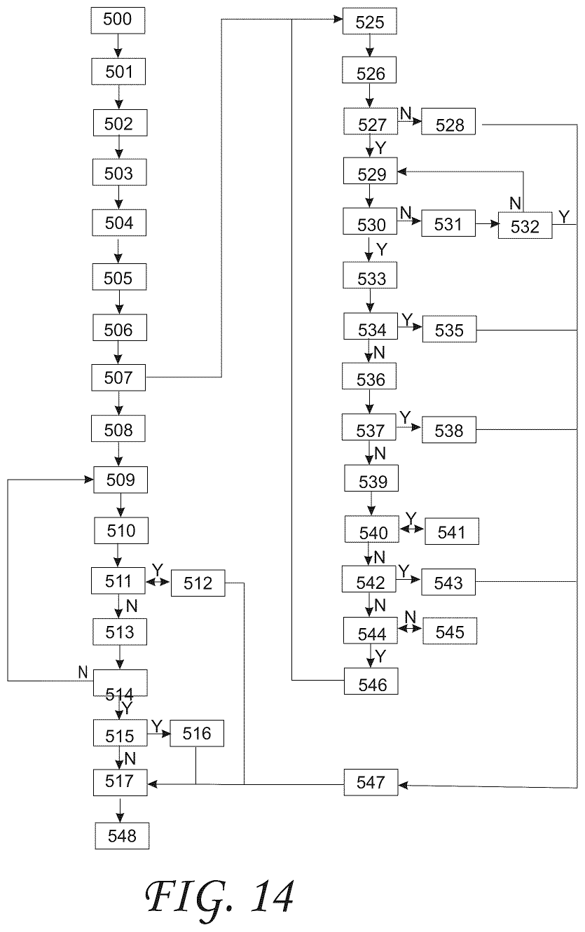

A representative test-taking sequence is illustrated in FIG. 14 and can comprise the following steps, again not all are required:

| | |
|---|---|
| 500 | User selects test to take. |
| 501 | Web server obtains the test from the test-provider. |
| 502 | Server uses Headset's cryptographic key set for communication. |
| 503 | Web server obtains Headset public key from the database. |
| 504 | Web server processes and encrypts the test using Headset public key. |
| 505 | Encrypted test is transferred to Headset using https: |
| 506 | Headset decrypts test using its private key. |
| 507 | Start test monitoring. |
| 508 | Start test timer and initialization of other parameters (pupil, # of pauses etc.) |
| 509 | Headset displays the next test question. |
| 510 | User chooses multiple choice answer using mouse which is recorded. |
| 511 | Has allotted time been exceeded? |
| 512 | Display “maximum test time exceeded”. |
| 513 | User advances or goes back to another question or indicates test is done. |
| 514 | Is user done taking test? |
| 515 | Has pupil size change flag been set? |
| 516 | Send warning message to server “possible fake iris contact lens in use”. |
| 517 | Display “End of test”, transfer test answers to server, stop monitoring. |
| 525 | Start test monitoring tasks. |
| 526 | Acquire iris image - flash white LED or turn on IR LED. |
| 527 | Compare iris image with memory. |
| 528 | Display “Iris has changed, unrecoverable error”. |
| 529 | Acquire eye location image, measure pupil diameter, and set flag if pupil |
| | diameter has changed. |
| 530 | Is eye located properly and has pupil diameter changed? |
| 531 | Display “eye location error, test paused, right click to restart”. |
| 532 | Increment pause counter, check for maximum pauses and sense right click. |
| 533 | Acquire cross-view camera image. |
| 534 | Analyze cross-view camera image for anomalies. |
| 535 | Display “cross-view image contains an anomaly, unrecoverable error”. |
| 536 | Acquire forward view camera image. |
| 537 | Analyze forward view camera image for anomalies. |
| 538 | Display “forward-view image contains an anomaly, unrecoverable error”. |
| 539 | Activate buzzer. |
| 540 | Acquire and analyze sound interval from microphone. |
| 541 | Display “warning sound from microphone contains an anomaly”. |
| 542 | Acquire interval of sound from contact microphone. |
| 543 | Display “User is talking, unrecoverable error”. |
| 544 | Acquire and analyze interval of heartbeat data or skin temperature data from |
| | blood flow monitor and EKG data. |
| 545 | Display “contact microphone not in contact with cheek”. |
| 546 | Wait 1 second and then Continue. |
| 547 | Display “Test terminated on error”. |
| 548 | End of test (after 517). |

Note that in at least one version of the system, connection to the internet can be lost and once the iris is verified, no other interaction with the internet is required until it is time to upload the test answers or download another test or lecture.

When the test-taker engages in taking a second test later, a new biometric scan will be conducted to ascertain that this is the same person who originally registered using headset 20. If this scan comparison is successful (as determined by a processor on the server), then the display 27 will be activated and a signal can be sent by the processor to the test-provider to forward the encrypted test.

There are various sensors including the forward-looking camera, the iris imaging camera, the cross-view monitoring camera, and the microphone and contact microphone, which provide data which contain patterns which are appropriate for neural network analysis. In some cases, initially this analysis can be simplified by using differences between two images. For example, for the cross-view camera which monitors the space from the eye to the display, it is expected that the image from this camera should be invariant and therefore any significant changes in that image would be indicative of an anomaly which should be brought to the attention of the test-taker for remedial action. Similarly, once the test has begun, there should be no voices sensed by the microphone 24 or the contact microphone 38 and therefore if any voice frequencies are present, the anomaly can be highlighted for remedial action by the test-taker. This lack of sound requirement for microphone 24 may be difficult to enforce so a contact microphone 38 is provided to detect whether the test-taker is talking. If talking is detected, the test can be interrupted and if it happens a second time, the test can be terminated, or other sound-detection responsive protocol followed.

The above description centered around test taking. A similar procedure exists for proprietary lecture viewing but since it is like the test-taking procedure above, it will not be described here.

Eye image analysis to detect that the eye is properly located in the FOV of the iris camera can be somewhat complicated, however, again since it is the difference between two such images which is significant, the analysis can be relatively uncomplicated. Iris identification biometric software is commercially available and does not impose a significant computational load on the processor. Generally, it will be done on the remote server since it only needs to be done at the beginning of the test-taking or viewing experience. To guard against use of a contact lens with a painted surface showing an invariant iris image to an iris imaging camera, the size of the pupil is monitored by the headset 20 via pupil image analysis. The pupil diameter changes over time even when the background lighting level is invariant. Therefore, if by the end of the test, the pupil has not changed in diameter such a painted contact lens is suspect and can be flagged as an anomaly.

A device that can be used for secure testing and teaching is described above. Now that the key principle that the test and/or lecture must be only seen by the student has been presented, it is possible to optimize the entire educational process to fit the needs and capabilities of the student so that material is learned in the most efficient manner. When an instructor teaches a class of students, the smart students may become bored as the teacher is going too slowly whereas others have trouble keeping up and can get lost. Since no two students learn at the same pace and even a given student may learn part of the course easily but struggle with another part, the teaching of a course cannot be optimized for any student with the result that all are learning at a suboptimal rate. Teaching a course online, on the other hand, offers the potential, as described below, for pacing the course so that it matches each student's abilities. This is true for the course as a whole and for each part. This concept has been understood but could not be effectively implemented unless each student was individually tutored since there was no known way to assure that the student did not cheat. With the secure testing device described above, for the first time, the pace of instruction can match the student's ability to learn. Each student will thus learn at the optimum efficiency. The fast learning students can proceed at the maximum speed and obtain credit in the shortest time. The slower students also will not waste time by dropping out of a course and having to retake it or change their major.

Since individual tutoring is prohibitively expensive, personalized education requires that teachers be replaced by technology. A representative sequence can comprise:
1. Making sure that the student has a valid reason for taking the course. Does he/she understand what he will learn and how it will fit into his/her overall plan. Is it part of the education that is expected for obtaining a particular job, for example? This can be determined by having the student answer a series of questions about the student's career goals and comparing the answers to the job requirements.
2. Determining whether the student can master the subject matter. Again this can be determined by a series of questions.
3. Determining whether the student has the background to handle the course. Presumably the student's academic history will be available for answering this question as well as one or more quizzes to assure that the student still knows the material.
4. Does the student have sufficient motivation to master the course. This might be hard to determine but motivation can be accessed periodically as the course progresses.
5. Once the course starts, the student can be continuously tested to make sure that he/she has learned the material that has been presented. If the student misses a question on the test, additional material can be presented directed to the missed concept and the test repeated with slightly different questions. This can be repeated as many times as necessary to make sure that the student has learned the material before proceeding to the next concept. Grades in effect now become meaningless as each student will not be permitted to proceed unless he/she has mastered the material. Everyone that completes the course gets an A. Perhaps those that complete 90% can be awarded a B and so on but that can be left to the school.

Each course thus proceeds at an optimum pace for each student. The estimated time to complete the course can be estimated and periodically presented to the student allowing him/her to decide that he or she does not want to invest the time required to finish the course.

Preferably, the course lectures, when lectures are used, will closely follow a textbook or other written matter so that the student can study the material offline. Homework can be optional and grades on homework eliminated since it would be difficult to guarantee that the student did the work without help. Also, this removes the temptation to cheat on homework. Since they are not graded, students can use homework to get help from the teachers or AI tutor. The lectures when used can contain extraneous material, but the student should know that he/she will not be tested on such added material. The course should be fact based and not express the opinions of the teacher. In some cases, the questions that are on a final examination can be published. 1000 such questions can be published, and the teacher can tell the student that the final exam will be randomly chosen from such a list. In many cases there will not be a need for a final exam as the student will have been continuously tested during the course.

To summarize, a student registers to take a course and obtains a headset. The headset guides him/her through a complete course with lectures if present, homework, and very frequent tests. If he/she misses a question on a test, he/she is provided more instruction until he/she gets a perfect score on the test after which he/she can go forward. The headset prevents him/her from cheating on the tests and the questions can be changed each time he/she takes a particular test. Once he/she passes the test he/she can go on to the next section of the course. He/she can quit the course at any point and his or her grade can be based on how far he/she got through the course. If he/she completed the course, he/she gets an A regardless of how long it took. This concept is largely described in the book The One World Schoolhouse by Salman Khan although of course he does not know of the headset presented here which makes the implementation of this system possible. Khan mentions in his book that repeated testing is one of the best ways to learn.

Note that with this system one or more courses can be taken at same time and from different schools. In fact, there is no limit to the number of courses that can be taken simultaneously. Homework is just practice. It need not be graded. If it is not graded there is no incentive to cheat. It can be graded for the student but not for the course grade. Video-based lectures and student discussion forums typically form the core of the MOOC instructional experience, and both can be used here. However, the main source of instructional information is textbooks.

In a traditional on campus class, students are frequently not paying attention. This is a problem with how the course is presented. Anyone who has tried to teach themselves new STEM material by sitting quietly and reading a textbook can tell you that this is a very difficult way to truly absorb most STEM concepts. Even bright, motivated students will find it challenging to maintain sustained concentration on this content, never mind fully understanding it. The system described here tests frequently to make sure the student is paying attention and learning the material.

For a school to be accredited, the accrediting agency reviews the courses and course content that the school intends to present for the student to be awarded a degree in the subject. A school may have some courses accredited and others not. Thus, it is in the makeup of the course that determines accreditation. Accredited schools can allow credits to be earned at another school and transferred and count toward the degree if the transferring school is accredited in that department. Thus, theoretically, an online school can be constructed by combining courses from accredited schools which can award accredited degrees. Now accredited schools can grant degrees to students that take one or even all their courses online. However, there is no assurance that the student didn't cheat while taking the required examinations to pass the required courses and thus there is no assurance that the student has learned the required material. This problem is solved using the teachings of this invention.

Let us review some of the cheating methods used by students taking online proctored courses.

A hidden camera that cannot be seen by the proctor's cameras copies test questions and sends them to a consultant. The consultant provides the answers by RF communication to a transceiver under the clothes of the student where the answer is converted to sound and transmitted to the bones of the student through a contact speaker or optically. This method is prevented by not allowing the hidden camera to see the display. The cross-view cameras constantly search for such cameras hidden to where they can see the screen. Such cameras would need to be mounted between the face and the screen where they can be seen by the cross-view or iris cameras.

Display splitter is inserted into the laptop display circuit which transmits the display contents to the consultant who returns the answers as described above. The electronics of the headset are protected by a CID which prevents access to the display electronics.

Reading the questions by the student into a microphone connected to the consultant who returns the answers by a method described above. A contact microphone presses against the face of the student and receives all sound from the student's mouth. The fidelity of the microphone is periodically checked by transmitting a sound thought the contact speaker, or similar device, to guarantee that it hears sound from the student.

One student takes the test first and then helps a second student, then next time, the second student takes the exam first and helps the first student. Since the test questions are scrambled, no two tests are the same so remembering the questions and writing them down would be difficult. Also, the first student cannot see the test taken by the second student and therefore cannot help him unless the second student communicates the test questions to the first student, which is not possible.

Two students take the test together. Each student has a different test and communication between the two students is not possible so this cheating method will not work.

Sharing work with other students. All the tests are different so therefore sharing the answers will not work.

Have another student or outside party take a proctored exam for a student. Iris security biometrics checking prevents this possibility.

Have another student take the class completely for a student. The grades for the class examinations would be associated with the iris biometric of the other student. When the student applies for a job, the employer can check his iris and confirm that this is the student that passed the course and, in fact, all the courses required for the degree.

Have a twin or look-alike relative take the test for the student. Again, for the same reason as the previous example the iris would not match the employee applying for the job.

Cell phones with internet capability are used to search for answers to the test questions on the internet. This is especially facilitated by ChatGPT. This activity would be picked up by the forward camera causing the test to be terminated.

Texting answers from a consultant using a cell phone would be defeated by the front camera.

Take a picture of an exam using a cell phone. The exam is not displayed in a manner where a picture can be taken. If the headset is removed from the head the display is blanked. Also, only one question at a time is displayed.

Program formulas into calculators to use on tests. Calculators can be not permitted and would be detected by the forward viewing camera.

Copy and paste the exam to a word processing program. Copying and pasting of the test questions cannot be done on the headset.

Print the quiz or exam for another student. Printing of the exam cannot be done from the headset.

Crib notes/Open book. For closed book examinations, the forward camera would see the use of such material and the test would be terminated.

Giving fraudulent excuses to take the test later. Using the system disclosed herein, it should not matter when the test is taken. If the student starts taking a test and quits before finishing, a restart can involve a different test covering the same material.

There are many MOOCs given online and many from accredited schools. Nevertheless, no one has been successful in putting together an accredited degree program or even a respectable credential program based on such sources. The obvious reason is that these degrees or credentials are not respected since the potential employer knows that there is a high probability that the student cheated when taking the courses. As discussed above, until now, there has been no credible method of preventing cheating. The inventions discussed herein for the first time provide such a method.

These inventions have the possibility of disrupting the education industry by providing credible credentials which can be trusted by potential employers. What MOOCs don't offer are official college degrees, the kind that can get a student a job. And that, it turns out, is mostly what college students are paying for. It is now possible to put together a college curriculum of MOOCs either by creating or licensing them. In one design, how the student obtains the information necessary to pass tests is unimportant. Only the test grades are important and a system for granting credit is presented here. The students can be charged the cost of the course plus the cost of presenting it. In any case, without the need for buildings such an education will be very inexpensive.

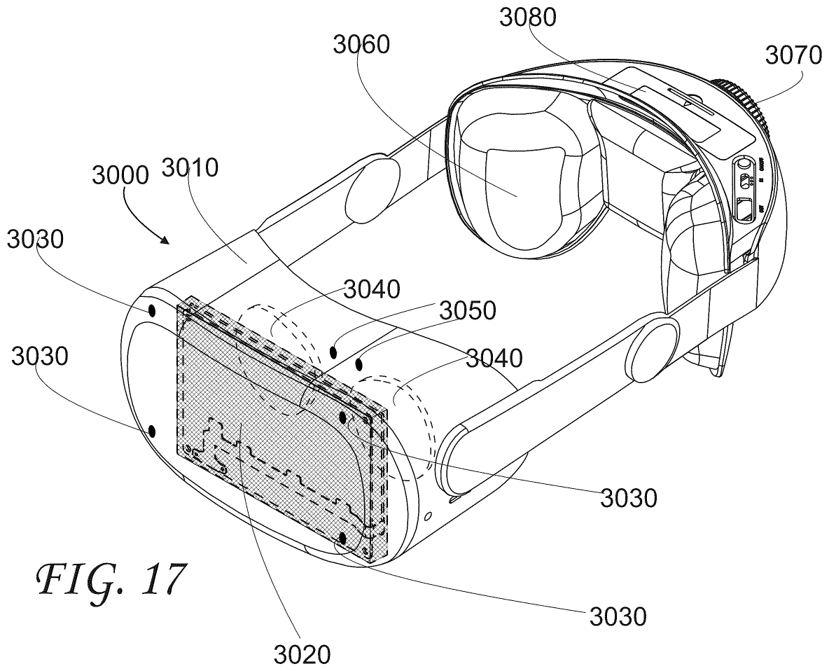

Another design of a head mounted display or headset is illustrated in FIG. 17. The headset is illustrated generally at 3000. The housing which holds the forward parts of the headset 3000 is illustrated generally at 3010. A display 3020 is fixedly or removably mounted in the housing 3010, and four forward-looking cameras 3030 are provided on the housing 3010. Two lens assemblies 3040 are also in the housing 3010 and adjust the image from the display 3020 to the eyes of the wearer of the headset 3000. If conventional lenses are used, the size of the headset 3000 becomes excessive to allow for the required distance between the display 3020 and the eyes of the wearer. Thus, either Fresnel, pancake, or meta lenses are used as described in other patent applications of the assignee which are incorporated by reference herein. Iris cameras 3050 are also on the housing 3010. A rear head support 3060 is spaced apart from the housing 3010 and an adjustment knob 3070 is used to adjust the headset 3000 to the head of the wearer. Batteries are placed in a housing 3080 in the rear head support 3060.

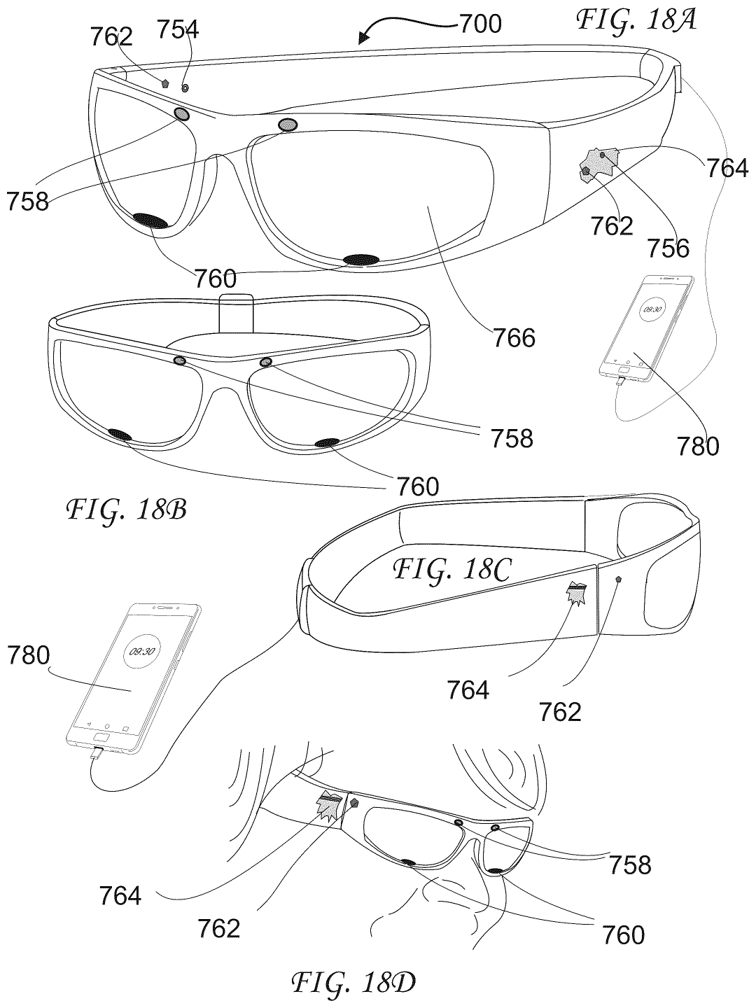

FIGS. 18A, 18B, 18C, and 18D illustrate another version of the headset which fits tightly around the face of the wearer giving the glasses control of the light environment surrounding the eyes. FIG. 18A illustrates a head-mounted apparatus 700 using the near-eye design of this invention. Preferably, the apparatus 700 includes a contact microphone 754 and two stereo speakers 756 one in each temple of the apparatus 700, two front cameras 758 one on each side of the nose bridge of the apparatus 700, two iris cameras 760 one at the bottom of each rim defining an aperture receivable of a lens, cross-view cameras 762 one in each of the temples, CID 764, and an electrochromic or liquid crystal filter 766 as or as part of each lens.

Forward viewing cameras 758, representative of an imaging device, monitor the field of view (FOV) of the test-taker outward from the glasses 700. Cameras 758 can have a field of view which can exceed 120 degrees. Contact speakers 756 are arranged in the housing in contact with the wearer's head and periodically provides a sound detectable by the contact microphone 754, also in contact with the wearer's head, to verify that microphone 754 has not somehow been rendered inoperable. The sound emitted by the contact speaker 756 travels through the head of the wearer so that both devices must be in contact with the head.

As shown here, a second contact speaker is used on the opposite side of the head to provide stereo sound, in which case only the speaker nearest to the microphone is activated to test the microphone. It has been found that some contact speakers do not emit sufficient sound pressure to be heard by the contact microphone. For these cases, a separate device which emits a single frequency outside of the hearing spectrum and at a much more intense sound level can be used. For this case, only a very short pulse would be necessary to confirm the proper wearing of the contact microphone.

The iris, or retinal scan, cameras 760, are arranged to point inward toward the wearer and measures biometrics of the test-taker. Such biometrics can include an iris or retinal image, an image of the blood vessels in the white portion of the eye, or an image of the portion of the face surrounding and including the eye. Illumination of the eye can be provided by IR LEDs arranged in connection with camera 760. Iris camera 760 is, therefore, more generally considered a biometric scan camera.

Software and a processor which controls test administration can be resident on an external server of the test provider and operate in conjunction with the electronics package in the housing of the glasses 700 or in an external device which is like a cellphone 780 and connected either by a wire 782 or wirelessly. Communication to and from this external server can be via the Internet.

Cameras 762 can monitor the space surrounding the eyes of the test-taker to assure that an image capturing device for providing aid to the test-taker is not being employed. This is achieved by processing images obtained by the cameras 762 using an image processing algorithm to determine the presence of another image capture device, e.g., image comparison or more generally image analysis using pattern recognition such as with neural networks. The camera 262, or more generally an imaging device, is arranged on the housing and oriented to image most of the frame.

The entire electronics package of the device can be encapsulated in a thin film called a chassis intrusion detector (CID) 764 as described above.

Forward-looking cameras 758 can have a field of view (FOV) of about 120°. This FOV will cover the hands of the test-taker to check for the case where the test-taker is typing the questions on a keyboard to be subsequently transmitted to a consultant. If the hands of the test-taker cannot be seen by cameras 758, i.e., are not present in images obtained by the cameras 758, the display will be turned off until the hands can be seen. If this happens frequently, the test can be terminated. Cameras 758 can also be used to check for the existence of other devices near the test-taker. These devices may include a tablet or other computer, a smartphone, books or papers, displays, or any other information source, including notes projected onto the ceiling, wall or floor, which are not permitted to be used for the particular test. If the test is an open book test, then use of some of the above-listed objects can be permitted. Software that accomplishes these pattern recognition tasks can utilize one or more trained neural networks.

FIGS. 18B, 18C, and 18D illustrate other views of the apparatus 700 as shown in FIG. 18A with FIG. 18D showing worn on the head of a person.

FIGS. 18A-18D also illustrate a cellphone or alternately an electronics package 780 indicating that the apparatus 700 can be used in one of two modes. When the cellphone is attached, the device acts like a monitor for the cellphone 780 but is not enabled to allow the wearer to take secure tests. Alternately, when the electronics package is attached secure test taking is enabled. In this case the electronics package is protected with a CID such as illustrated in U.S. Pat. No. 11,508,249.

Other features which can be added to the headset of this invention include:

Eye tracking of the wearer's gaze to pick an answer to a displayed question, highlight it and select by blinking.

GPS and IMU sensors.

Head motion sensing for control based on the IMU.

A Ring control device as a mouse replacement or supplement as disclosed in U.S. Pat. Appln. Publ. No. 20110221672 incorporated by reference herein.

Mapping objects in room for location fixing using images from the forward cameras in conjunction with the IMU and/or GPS sensors.

Typing using an augmented reality virtual keyboard.

Hand gestures, pointing, wave off.

Use finger pointing to answer multiple choice questions.

A control device worn on a hand of the user.

User control of external applications.

The processor correlates the displayed content and the information from the sensor to indicate the eye's line-of-sight relative to the projected image, and uses the line-of-sight information relative to the projected image, plus a user command indication, to invoke an action.

Paideia Services system.

For a universal online education system, certain issues should be addressed regarding students. Some of these are:
Does the student have the ability to succeed?
Can his ability be increased?
Does the student have the motivation to succeed? What are his goals?
Can his motivation be increased?
Are there economic or other external circumstances that inhibit proper attention?
Can these external circumstances be improved?

With the answers to these questions, calculate the chances for success.

Taking a class without a teacher requires high levels of self-motivation, self-regulation, and organization.

Personalized learning requires that teachers be replaced by technology.

This universal education system will initially be limited to fact-based courses that are capable of being efficiently taught. Politics and ideology will play no part in their administration or teaching. Later, other courses can be added, and laboratory required courses can be considered.

Education in the United States has become expensive, inefficient, of marginal quality, and influenced by political and ideological factors. Graduating students frequently do not have the training and abilities desired by industry. Progress through a course is determined by the ability of the average student in that course. Half of the students, therefore, are being held back and the other half are struggling to keep up. Time is additionally wasted by requiring class attendance and campus residency. For an engineering student capable of earning $100,000 per year upon graduation and paying $50,000 per year for tuition plus an additional $50,000 per year for living expenses, the cost of an inefficient year of education is approaching $200.000. Thus, for every year that can be saved, $200,000 is added to the wealth of the student.

Starting with a school and a course, a standard textbook is chosen. Each chapter of the textbook is divided into teachable sections with each section, called a nugget, containing a single concept to be taught to the students. Several nuggets are combined to be covered by a quiz. Each student will be administered quizzes and progress through the course will not continue until a near perfect score is obtained by a student on a quiz. Each student can move as rapidly as he or she desires through the course if the quizzes are successfully passed. Each student in the class, therefore, proceeds at his own pace and is not controlled by the pace of other students in the class. One student might be capable of completing a course in one month whereas another may require a year. In either case, both students will have mastered the material by the end of the course. Questions on the periodic quizzes will also include random questions from previous sections to assure that the student has not forgotten the previous material.

Courses are taught online eliminating the inefficiency of having to attend classes in person or to reside on campus. Alternatively, a combination of online and campus-based courses can be taken by a student.

Prior to taking a course, a student must demonstrate that he/she has the background and capability of understanding and learning the subject matter.

Quizzes will be administered periodically as determined by the student and will contain questions chosen at random from a large list of such questions covering the subject matter to be tested. A student may take the current quiz a reasonable number of times. Each time different questions will be chosen for the quiz so that learning from previous tests will not benefit the student. After several failed attempts, the student will be required to demonstrate that he is able to understand the subject matter covered by the test.

There will be no required lectures, thus, no significant effort will be required to prepare a course so this educational system can be developed rapidly, probably starting with a single interested school. Once the system has been perfected it should grow rapidly.

ChatGPT or its equivalent, generally a Chatbot, can replace lectures where some tutoring is needed for a particular student. After the student has read a section of the textbook, he or she can log on to the Chatbot and ask any number of questions until he or she thoroughly understands the material. Thus, the AI system replaces the lectures with a far more efficient virtual tutor.

When fully implemented, the cost to the student for obtaining a degree should be minimal. Standard available textbooks will be used, and the testing costs can be covered by small fees paid to Paideia Services, LLC. Since a school can handle many more students by this system, the cost per student should be minimal and the income to the school can increase. There will be no need, for example, for buildings, residencies, or extensive staff. When fully implemented, a full-time student, therefore, should be able to complete the requirements for a college degree in substantially less than four years at a small cost compared to that of a traditional college education.

During partial implementation, these services to various schools will be provided by Paideia Services, LLC. Paideia Services will structure each of the courses according to the Paideia Services system. The initial implementation of the Paideia education system will be on a school-by-school basis. After a period, Paideia Services will have accumulated sufficient recognition to be able to offer degrees under the name of Paideia Institute of Technology.

The Paideia Services educational system will be presented to schools while the SecureTest® cheating prevention system is presented. The goal will be to get existing schools to try the new system either for existing courses or for courses that they do not currently offer. The cost of presenting a Paideia Services course is substantially less than other courses offered by the school since they will not need to employ a professor or incur other related course costs. The schools will find out that they can substantially increase the size of their student body for this reason. Thus, schools can increase their revenue without significantly increasing their costs.

At the first time that a particular course is taught, the textbook must be converted to the Paideia Services system. This is done by initially obtaining an editable version of the chosen text. A person familiar with the subject, a professor for example, will work through the book identifying the Nuggets and dividing the text into sections. Also, many questions must be created to support this teaching method. This effort only needs to be done once for a particular course.

Paideia Services is currently preparing such a course based on the textbook Elementary Statistics by Mario F. Triola, 14th edition, for demonstration purposes. While selling the Secure Test cheating prevention system, a salesman will also demonstrate this course to prospective schools.

Once a course is prepared by Paideia Services, it can be offered to other schools without incurring this initial cost. Since the course will be offered by accredited schools, the courses can also be argued to be accredited.

The key enabling technology for this educational system is the SecureTest® headset. This device makes it possible to administer tests with the confidence that cheating did not occur. Without this cheating prevention technology of the SecureTest headset, the above education system could be difficult to implement.

The standard textbook path allows for the rapid expansion of this system. As the results from quizzes occur, the textbook used for the course may need to be supplemented to better teach areas with poor test results. This can also be accomplished through future textbook editions working with the author and/or publisher. Also, as technology changes, textbooks need to reflect these changes. Thus, textbooks can continuously improve since rapid feedback through the quizzes will be available.

The information to be taught is divided into roughly equal parts called nuggets. As experience is gained, these nuggets can be changed to render them more equal in learning difficulty. Each nugget will be represented in quizzes allowing a measurement of the difficulty of the nugget and thus the opportunity to expand the difficult ones and reduce the easier ones. Nuggets which pose a problem for a student can be included in later quizzes to assure that the student has learned the nugget.

The implementation plan is to start replacing one or a few courses at established schools. The substituted courses will essentially be the same as existing courses and therefore should have no effect on the degrees granted or accreditation. The success of the system can be measured by comparing test scores between online and on-campus students taking the same course. A Paideia Services course can be easily offered by any school that uses the SecureTest cheating prevention system since it can be built into the SecureTest software. Where the student chooses a course, he or she only needs to specify a Paideia Services course. Then, rather than attending a class at the school, the student will attend the Paideia Services class online.

Later, when Paideia Institute of Technology is started, it should automatically be accredited since all its courses are accredited at other institutions.

The courses are all to be taught from standard textbooks and therefore there should be no intellectual property issues with the courses or their content.

Example: Jack decides to take a Paideia Services computer science course. If he is not doing so through his existing school, he registers online, acquires a headset, and acquires a computer science 101 textbook. Jack studies chapter one of the textbook and then signs onto a Chatbot, such as ChatGPT or equivalent if he has questions that were not covered in the text. He engages back and forth with the textbook and the Chatbot until he is confident that all his questions are answered. Then he can log onto the course provider using his SecureTest headset and prepare to take a quiz covering the section of the text that he has been studying. The course provider then identifies Jack by his iris and asks Jack if he is ready to take a quiz. If Jack answers yes, then the questions appear one by one on the display. Jack proceeds to answer the questions and if he answers them correctly, Jack is given credit for the section and allowed to move on and repeat this process for the next section.

During this process, Jack will be presented with many questions and exercises in the textbook so if he studies and understands the textbook and does the exercises, he should not have a problem with any of the questions asked by Secure Test later.

Teaching session structure example:
Hello Jack,
Do you have any questions?

Chatbot answers the questions.

Paideia Services asks some pre-quiz questions to ascertain that Jack is ready to take the SecureTest test.

If Jack answers all pre-quiz questions correctly, then SecureTest is started, and the test is presented.

If Jack fails the test, then he must return to studying the book and the process is repeated.

If he passes with at least 90% then he can go forward to the next section.

The questions that Jack found difficult will be asked again in a different format later.

This educational system has no required lectures. The Chatbot acts as a tutor to the student if needed. Since there are no professors or lectures, any textbook can be used and even changed every year. Only test taking will require the use of the SecureTest headset. All other activities require only the use of a computer and access to the Internet. Once a textbook has been chosen, Paideia Services will divide the text into sections for testing purposes and create a list of questions to be used by the SecureTest headset for each assessment. Note that to pass the student must obtain a 90% score on each quiz and each quiz will include random questions that the student previously missed, each student will finish the course with an A grade.

### Analysis

It has been suggested that an AI tutorial system is the gold standard. Alexander the Great needed Socrates but only because there were no textbooks or AI tutors. If the student has the proper background and the text is well written, then a tutor is only needed if the student is not capable of understanding the textbook or if he has forgotten something that he read recently. In either case, the AI tutor can be useful but adds time inefficiency to the learning process.

For most liberal arts courses, such as history, sociology, and psychology, the subject matter is not difficult to understand, it just must be committed to memory. In such cases a tutor is not required. A tutor is probably also not needed for business classes such as accounting, marketing, finance and probably not for law school classes. Everything taught in these schools is not difficult to understand. It is just information which must be learned by the student so that he has the background and resulting judgment to succeed in various fields.

### Competition

The Khan Academy, which is based on a tutorial system, has achieved significant success. Most of the students are from grammar and high schools where many students have yet to become self-motivated. Higher education involves a significant financial investment and therefore college students are expected to be motivated. Of course, there will be many examples of where the background of the students is not sufficient to prepare them for college courses. For some such students, tutorial assistance may be desirable. This should be the exception and therefore the learning system should not be built around the use of tutors, but AI tutors can be available when needed.

### Plan—Company

One approach is that a student can begin by enrolling at Paideia Services, LLC, and then, after experiencing a few courses, can apply to a college of his choice after he has had some experience of obtaining a college education, at very little cost. Since most colleges have a significant drop out rate after the first or second year, they will have space for transfer students from Paideia Services. Since the quality of the education received at Paideia Services will be excellent, there should be no problem transferring into many existing schools. Also, if the school is using the Secure Test system, incorporation of Paideia Services courses can happen automatically.

One experiment that can be implemented without affecting any the other part of the school's curriculum would be to test both their teaching method and the Paideia Services method. At the end of the semester, it will be clear how well the Paideia Services teaching method works by comparing the results of an experimental Paideia class with the results of an ordinary class. The final exams for both classes can be the same for a perfect comparison.

Since it does not involve a professor, a course can be set up quite independently of the rest of the school. This system also removes much of the school's administrative efforts. Even payments for courses can be handled through the Paideia Services system. The school could separately charge for residences, for example, and other non-course related charges. This makes it very easy to significantly expand the student body without a corresponding increase in administrative costs if the students do not reside on campus.

Another approach is to make Paideia Services the learning management system (LMS) for the student. In this case the student logs on to Paideia Services and is presented with the courses that he has previously arranged to take. He then chooses which course he's going to proceed with and then follows the SecureTest cheating prevention path. In this case courses can be from different schools if there is some arrangement whereby the credits can be accumulated, and a degree awarded, from a particular school.

In this case, the system is controlled by the Paideia Services software giving much better control over how the system is implemented at various schools.

Since the same courses can be taught at various schools, the school reputation becomes less significant. This makes it very easy to later create Paideia Institute of Technology since all the teaching and grading will be handled through Paideia Services.

### Sales and Marketing

A student can take a few courses at Paideia Services and based on his record with those courses, he can apply to various colleges and universities with a high probability of being admitted based on his record at Paideia Services. This reduces the risk to the colleges that the student will not complete the coursework.

Another possibility is to arrange with a local college or struggling institution to allow piggybacking off their system to get the Paideia Services system operating. There are approximately 2,410,000 students in higher education in 4500 schools in the United States.

This system should be very attractive in a country such as China. They will have complete control over the textbooks used and thus the subject matter that is being taught. They also would have complete control over the grading system, and they would know that any student who makes it through the system will know the technology very well.

### Structure

As lectures are obsolete so is essay writing. A student can present ideas to a Chatbot which can then convert those ideas into readable text. The student can then review what was written and correct any errors. Thus, if necessary, essay tests can be answered orally or preferably just eliminate essay tests completely.

It is easy to incorporate a new course into the Paideia Services system. All that really needs to be done is to add it to the system and create assessment questions for quizzes based on the chosen textbook.

### Textbooks

Each course can be structured so that it follows a structure such as is discussed, for example, in the preface and in various sections of the book Elementary Statistics referenced above. This includes a test as to whether the student is prepared for the next section, references to available videos, websites such as described in the author's website and the publisher's MyLab, etc. Each course will be run using a Paideia Services online program to track the student's progress and determine, using sample quizzes, whether he is ready for the Secure Test section quiz.

The initial work will be to select a textbook for a particular course and create a Paideia Services course from the text. This essentially means creating examination questions, initially using the questions that are in the text, and then adding some for the SecureTest quizzes, and to see if the student is ready for the SecureTest section quiz.

As an aside, Paideia Services can operate as a textbook censoring tool in that it will not allow any text to be incorporated into its classes that is not free from political or other biases. Eventually, a collection of nonpolitical textbooks will be identified. Some courses are inherently political, such as history, so a method of censoring such books to remove as much of the political bias as possible needs to be implemented. No school will be required to use Paideia approved texts. However, Paideia courses will only use such texts. PAT will stand for Paideia Approved Text. Since there are good foreign language translation systems, any Paideia text can be translated into the language of any country.

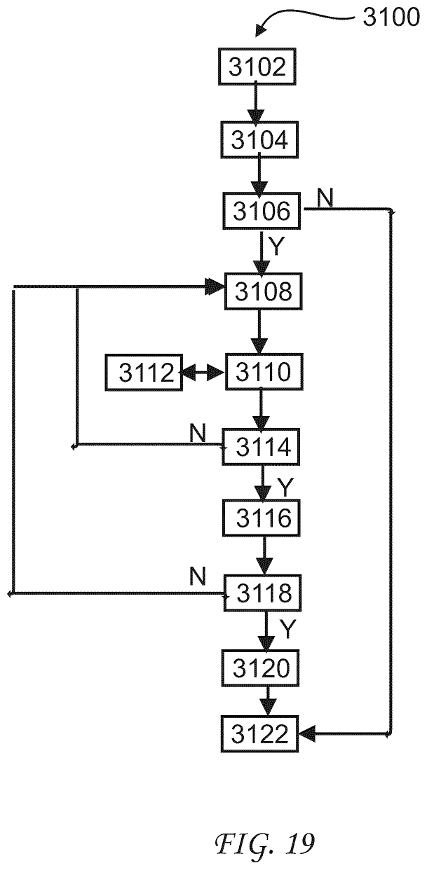

Steps for a Paideia Course as shown generally at 3100 in FIG. 19
Step 3102—A student registers with SecureTest and chooses to take a Paideia Services course.
Step 3104—The student acquires the specified textbook—Use Elementary Statistics as an example.
Step 3106—The student is tested for prerequisite knowledge. If he passes, then he is cleared to proceed. If he fails, then the missing knowledge is identified, prerequisite sources are prescribed, and the session terminates at step 3122.
Step 3108—The student studies section 1 of chapter 1 (˜10 nuggets).
Step 3110—The student is asked if he has any questions. If yes, Chatbot is invoked until all questions are answered (tutorial session). If videos or MOOCs are available, the student is given an opportunity to view them at 3112.
Step 3114—The student is tested on section 1 by the Paideia Services system. If he passes, he proceeds to section 2. If not, he must restudy section 1.
Step 3116—The student repeats this process for section 2 through the end of the chapter.
Step 3118—After completing the chapter, for example, the student is tested by SecureTest®. If he fails (<90% correct), then the process above is restarted at 3108. If he passes, then he can proceed to the next chapter.
Step 3120—Repeat the process until the course is completed.
Step 3122—End.

For a Paideia course, SecureTest receives the test questions from Paideia.

This procedure assumes that the student is registered with a school. If not, then the student can register with Paideia Institute of Technology when it is established or Paideia Services if he plans on transferring to a school.

From FIG. 19, a method for generating an indication of completion of an education or vocational course by a student in accordance with the invention (which can use the system shown in FIG. 12) includes registering the student for the course by obtaining identification information about the student including biometric data (achieved for example, using server 400, the institution 402, the network 404, the headset 406 and/or the computer 408), directing the student to study each of a plurality of segments that in their entirety constitute the course, and performing a test of each of the plurality of segments to determine whether the student has understood each of the plurality of segments. As used herein, a student is defined as anyone taking an education or vocational course, or other type of course, for which testing and understanding or comprehension of the course material is required to provide an indication of completion of the course. This indication may be an updated of a student record, i.e., a change in the student record to include mention of a completed course.

The testing entails directing the student to place a headset 406 on their head in a position in which content of a display of the headset 406 is readable, the headset including at least one user interface configured to receive input from the student while the headset is on the student's head, and performing a biometric verification to verify the identification of the student taking the test of each of the plurality of segments is the student registered for the course. This biometric identification can be performed using a biometric identification device on the headset 406.

The testing then involves presenting a set of questions on the display which constitute the test of each of the plurality of segments and receiving via the at least one user interface, a response to each question from the student taking the test of each of the plurality of segments. The responses may be conveyed to the server 400 through the network 404 and stored in a memory component at the server 400. After a response to a last one of the set of questions presented on the display is received from the student taking the test of each of the plurality of segments using the at least one user interface, passing of the test of each of the plurality of segments is determined using a processor, e.g., at the server 400, in the headset 406 and/or in the computer 408. The passing of the test of each of the plurality of segments is associated with the identification of the student provided through the biometric verification in a database, e.g., at the server 400, and then an indication of passing of that segment is generated and stored in the database. 20. Passing of the test may be determined by grading the test relative to a threshold.

When the test of any of the plurality of segments is not passed, the student is notified via a telecommunications device, e.g., network 404, that they must repeat the study of that segment and the test of that segment. Finally, a record in the database associated with the student is updated to include an indication of completion of the course only after indications of passing of all of the plurality of segments have been stored in the database.

Often the course has required background knowledge, in which case, the method preferably includes performing a preliminary test to determine whether the student has the background knowledge required for the course essentially as explained above. A set of questions is presented on the display which constitute the preliminary test and passing of the preliminary test is associated with the identification of the student provided through the biometric verification to indicate acceptance of the student for the course. Otherwise, the student is notified via a telecommunications device that they are unable to take the course.

Directing the student to study each segment may involve prompting the student to interact with a chatbot to respond to questions asked by the student relating to the segments and/or notifying the student via the telecommunications device of available videos and online courses relating to the segments. The materials for the course may be segmented into a plurality of segments by partitioning a textbook about the course into sections and audio and/or video content for each section generated or otherwise retrieved if already available.

Presenting the set of questions on the display may entail generating using the processor at the server 400, in the headset 406 and/or in the computer 408, the questions based only on the segment being tested and any segments previously tested and/or presenting using the processor randomly selected questions from a set of questions in the database.

When the database is remote from the headset, the method may entail downloading using a wireless telecommunications connection the set of questions from the database prior to presenting of a first one of the set of questions on the display so that presentation of the set of questions is not interrupted by failure of the telecommunications connection.

Directing the student to study each of the plurality of the segments may entail presenting material relating to the segment on the display of the headset. The student may be directed to sequentially study each of the plurality of the segments and the test of each of the plurality of segments is performed in sequence.

A method for administering tests of an education or vocational course based on the method outlined in FIG. 19 and possibly using the system depicted in FIG. 12 includes providing tutoring in the course to a student to whom the test is to be administered using a computer having at least one of audio and video output accessible to the student and a server connected to the computer and separately providing each of a series of segments of the course. Each segment of the subject is tested and passing of the test is required prior to advancement to a subsequent segment in the series of segments. Also, the method involves detecting during the tutoring of each segment a request from the student to be tested on that segment, and directing the student to place a headset on their head in a position in which content of a display of the headset is readable. The headset includes at least one user interface configured to receive input from the student while the headset is on the student's head. Biometric verification is performed to verify an identification of the student taking the test, e.g., using one or more biometric identification devices on the headset and a dataset containing known biometric data of the expected student.

A set of questions is presented on the display which constitute the test and a response to each question from the student taking the test is received via the at least one user interface. The responses to the questions are stored in a memory component, e.g., at the server 400. After a response to a last one of the set of questions presented on the display is received from the student taking the test using the at least one user interface, passing of the test using a processor is determined, e.g., at the server 400 having been provided the responses via the network 404. Passing of the test is associated with the identification of the student provided through the biometric verification in a database, e.g., at the server 400. The same enhancements described above may be applied to this method.

### Summary

This invention, in addition to eliminating cheating on tests conducted over the internet, makes it possible for the successful administration of tests and presentation of lectures regardless of the status of the internet. Students taking an examination or watching a lecture are not limited by the availability of an internet connection once the test or lecture has been downloaded to the headset. Once a student starts taking a test, in contrast to proctoring services, he or she can complete the test regardless of the status of the internet connection. After completion, the test answers can be uploaded to the server once the internet connection is reestablished. In fact, under this invention, a student can download multiple tests and then complete the tests without an internet connection.

Similarly, a student can download one or more lectures, for the implementation where it is the courseware that needs protecting and reviewing the lectures at his/her leisure remote from the school and without concern about continuous internet availability. The student does not need to reconnect to the internet even if he/she removed the headset from his/her head if the iris recognition software is implemented on the headset.

During viewing of the lecture by the student, or taking of the test by the student using the headset, a biometric input device on the headset obtains biometric data, e.g., pictures of the iris of the student or the test-taker taken by an iris camera or cameras, and this obtained biometric data is transmitted through a telecommunications device on the headset to a remote location for analysis and identification. However, when the iris identification, or other biometric data analysis, is performed on a server or other analysis device at the remote location, the biometric input device on the headset thereafter is used to determine that the eyes of the student or test-taker are continuously in view of the iris cameras, and if not, the test or lecture is stopped. Even though the iris check is performed on the server at the remote location, after the first check and verification, the presence of the eyeball, which can be done on the headset, is continuously performed and at a selected time interval so that the student or test-taker student cannot remove the headset and put it back on without it being detected.

Another issue is the download speed. In the embodiment wherein the headset is used to experience a lecture, but which is also applicable to a large test, it might not be feasible or realistic to wait until the entire lecture or test is downloaded prior to beginning the lecture or test. If the internet connection is lost during the downloading, the student or test-taker will need to reload the lecture, or the missing part or parts, to see the whole lecture or be able to take the entire test. One solution is that if the lecture or test is not completely downloaded, the lecture or test can be stopped and the student or test-taker can be notified to redownload it. Generally, the download time will be maybe 25% of the viewing time, depending on the speed of the internet.

There are other possibilities to address the issue of downloading an entire lecture before starting it. For example, the lecture can be segmented, and each segment downloaded while there is an Internet connection (for the purposes herein, a lecture segment will still be considered a lecture which must be downloaded in its entirety to enable viewing or listening thereto during possible Internet interruptions, or other download issues). Before each segment of the lecture, the biometric identification protocol is undertaken to ensure the person viewing and/or listening to the lecture is the intended and authorized person to view and/or listen to the lecture. High speed download channels can be established to download the lectures, as well as tests.

A substantial number of sensors have been introduced, each of these sensors requires at least one algorithm to assess sensor output and determine whether the test-taker is cheating or not. Since the Headset is provided with a chassis intrusion detector (CID), it is virtually impossible for a consultant to modify the apparatus to transmit the display information to another room, for example. With a CID, there are no accessible wires which connect the display to the electronics package, for example. A second CID protects the combiner from optical intrusion.

Finally, the display itself is protected. The test-taker can wear a camera which has a lens the size of a small pea but for that camera to see the display, it will also be seen by the iris imager or the eye-to-display crossview cameras since there is a very limited viewing area for the camera to see the display.

Some important features of this invention differentiate it significantly from prior art attempts to develop secure testing systems. These include:

A wide field of view optical system with protection from an outsider viewing the test or lecture when it is in progress but allowing for a view of the environment and the development of augmented displays which are believed to be useful with future teaching strategies.

Apparatus and a method for attaching devices external of the protected electronics package while maintaining the maximum security.

Using liquid crystal technology, the view through the combiner can be blocked adding to the security of the secure test taking lecture viewing apparatus and method. In this case, the liquid crystal blocking film can be turned totally black or opaque by a control mechanism so that the contents of the display cannot be seen from a person standing in front of the test-taker.

Other methods can be used with the headset to permit the test-taker to enter commands to the headset. One such method using the iris camera is to track the motion of the eye which is usable to select answers to the questions or to control the operation of the headset. Eye blinking and time or duration of eye closing also can be used for this purpose. Another such method is to use gestures which can be seen by the forward-facing camera and interpreted by appropriate software. Teeth clicking, for example, can be used for controlling the test and for choosing various of the multiple choices for a test question.

Methods for taking tests and administering tests and displaying lectures using the headsets described above are also considered to be part of the invention. Methods for ensuring a test-taker or viewer is not cheating are also considered to be part of the invention. Although the headsets described herein are for particular use for test-taking and lecture viewing, they are not limited to such use and other uses for the headsets, e.g., gaming, and internet surfing are also considered as being part of the invention.

A computer program will be resident in the headset, i.e., on an electronic component therein, and configured to perform the foregoing functions when executed. The program will be embodied in any type of computer-readable media and associated hardware and configured to control the hardware components of the headsets, including but not limited to the telecommunications device, the display, the user interface, the audio generating system, the processing functions of the processor, etc., all to enable operability of the program to perform the test administration functionality, the lecture viewing functionality, both of these functions, and possibly other functions. Among other things, the program also performs the biometric identification protocol so it will also be configured to control the iris cameras and any other biometric identification devices.

In the context of this document, computer-readable medium could be any means that can contain, store, communicate, propagate, or transmit a program for use by or in connection with the method, system, apparatus or device. The computer-readable medium can be but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CD-ROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

To the extent the foregoing is deemed an inadequate disclosure or for other purposes, all patents, patent application publications and non-patent material identified above are incorporated by reference herein. The following patent publications to the same inventor, assignee and/or applicant are also incorporated by reference: U.S. patent application Ser. No. 16/740,748 filed Jan. 13, 2020 (published as US20200152075), Ser. No. 16/564,905 filed Sep. 9, 2019 (US20190392724), Ser. No. 16/107,164 filed Aug. 21, 2018 (US20180357916), Ser. No. 15/964,208 filed Apr. 27, 2018 (US20180247555), Ser. No. 15/793,313 filed Oct. 25, 2017 (US20180060613), Ser. No. 15/467,733 filed Mar. 23, 2017 (US20170193839), Ser. No. 15/329,243 filed Jan. 25, 2017 (US20170213471), Ser. No. 15/390,535 filed Dec. 25, 2016 (US20170185805), and Ser. No. 14/448,598 filed Jul. 31, 2014 (US20160035233), and U.S. provisional patent application Ser. No. 62/040,806 filed Aug. 22, 2014, 62/644,897 filed Mar. 19, 2018, and 62/668,965 filed May 9, 2018. The features disclosed in this material may be used in the invention to the extent possible.

Although several preferred embodiments are illustrated and described above, there are possible combinations using other geometries, sensors, materials, and different dimensions for the components that perform the same functions. At least one of the inventions disclosed herein is not limited to the above embodiments and should be determined by the following claims. There are also numerous additional applications in addition to those described above. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention which is limited only by the following claims.

1. A method for generating an indication of completion of an education or vocational course by a student registered for the course, comprising:
generating and storing in a database, a set of questions for each of a plurality of segments that in their entirety constitute the course;
performing a test of each of the plurality of segments, after receiving an indication that the student has studied each of the plurality of segments, to determine whether the student has understood each of the plurality of segments by:
directing the student to place a headset on the student's head in a position in which content of a display of the headset is readable, the headset including at least one user interface configured to receive input from the student while the headset is on the student's head;
performing, using a biometric identification system on the headset, a biometric verification of the student on whose head the headset is placed to verify the identification of the student taking the test of each of the plurality of segments is the student registered for the course;
only when the verification of the student taking the test of each of the plurality of segments indicates that it is the student registered for the course,
downloading, from the database to the headset, a randomly selected portion of the set of questions for the segment being tested prior to presenting a first one of the downloaded set of questions on the display, the downloaded portion of the set of questions constituting the entire test of the segment being tested such that the entire test is downloaded before starting of the test;
presenting the questions of the downloaded portion of the set of questions on the display in a random order and receiving via the at least one user interface of the headset, a response to each presented question from the student taking the test of each of the plurality of segments;
storing the responses to the questions provided by the student using the at least one user interface of the headset in a memory component;
after a response to a last one of the downloaded set of questions presented on the display is received from the student taking the test of each of the plurality of segments using the at least one user interface, analyzing using a processor the responses provided by the student to acceptable responses and based on the analysis of the responses, determining passing or failure of the test of each of the plurality of segments;
associating the passing of the test of each of the plurality of segments with the identification of the student provided through the biometric verification in a database and then generating and storing in the database an indication of passing of that segment for that student; and
when the test of any of the plurality of segments is not passed, notifying via the telecommunications device to the student that they must repeat the study of that segment and the test of that segment; and then
updating a record in the database associated with the student to include an indication of completion of the course only after indications of passing of all of the plurality of segments have been stored in the database,
whereby the random selection of the portion of the set of questions and the random presentation of the downloaded set of questions reduce the likelihood of any two students having the same questions in the same order and thereby reduce the likelihood of any one student taking the test being able to assist another student taking the same test of the course.

2. The method of claim 1, wherein the course has required background knowledge, the method further comprising performing a preliminary test to determine whether the student has the background knowledge required for the course by:
directing the student to place the headset on the student's head in a position in which content of a display of the headset is readable;
performing a biometric verification to provide an identification of the student taking the preliminary test;
presenting a set of questions on the display which constitute the preliminary test and receiving via the at least one user interface, a response to each question from the student taking the preliminary test;
storing the responses to the questions in the memory component;
after a response to a last one of the set of questions presented on the display is received from the student taking the preliminary test using the at least one user interface, determining passing of the preliminary test using the processor;
associating the passing of the preliminary test with the identification of the student provided through the biometric verification and indicating acceptance of the student for the course; and
when the preliminary test is not passed, notifying via a telecommunications device the student that they are unable to take the course.

3. The method of claim 1, further comprising:
directing the student to study each of the plurality of the segments that in their entirety constitute the course by prompting the student to interact with a chatbot to respond to questions asked by the student relating to the segments.

4. The method of claim 1, further comprising:
directing the student to study each of the plurality of the segments comprises that in their entirety constitute the course by notifying the student via the telecommunications device of available videos and online courses relating to the segments, each of the segments having at least one video or online course.

5. The method of claim 1, further comprising segmenting materials for the course into a plurality of segments by partitioning a textbook about the course into sections and generating at least one of audio and video content for each section.

6. The method of claim 1, wherein the step of presenting the set of questions on the display which constitute the test of each of the plurality of segments comprises generating using the processor the questions based only on the segment being tested and any segments previously tested.

7. The method of claim 1, wherein the step of presenting the set of questions on the display which constitute the test of each of the plurality of segments comprises presenting using the processor randomly selected questions from a set of questions in the database.

8. The method of claim 1, wherein the step of performing a biometric verification to verify the identification of the student taking the test of each of the plurality of segments is the student registered for the course comprises using a biometric identification device on the headset to obtain biometric data about the student.

9. The method of claim 1, wherein the database is remote from the headset, further comprising downloading using a wireless telecommunications connection the set of questions from the database prior to presenting of the first one of the set of questions on the display so that presentation of the downloaded set of questions is not interrupted by failure of the telecommunications connection.

10. The method of claim 1, further comprising:
directing the student to study each of the plurality of the segments comprises presenting material relating to the segment on the display of the headset.

11. The method of claim 1, wherein the student is directed to sequentially study each of the plurality of the segments and the test of each of the plurality of segments is performed in sequence.

12. A method for administering tests of an education or vocational course, comprising:
providing tutoring in the course to a student to whom the test is to be administered using a computer having at least one of audio and video output accessible to the student and a server connected to the computer and separately providing each of a series of segments of the course, each segment of the subject being tested and requiring passing of the test prior to advancement to a subsequent segment in the series of segments;
detecting during the tutoring of each segment a request from the student to be tested on that segment;
generating and storing in a database, a set of questions for each of the segments that in their entirety constitute the course;
directing the student to place a headset on the student's head in a position in which content of a display of the headset is readable, the headset including at least one user interface configured to receive input from the student while the headset is on the student's head;
performing, using a biometric identification system on the headset, a biometric verification of the student on whose head the headset is placed to verify an identification of the student taking the test;
only when the verification of the student taking the test of each of the plurality of segments indicates that it is the student registered for the course,
downloading, from the database to the headset, a randomly selected portion of the set of questions for the segment being tested prior to presenting a first one of the downloaded set of questions on the display, the downloaded portion of the set of questions constituting the entire test of the segment being tested such that the entire test is downloaded before starting of the test;
presenting the questions of the downloaded portion of the set of questions on the display in a random order and receiving via the at least one user interface, a response to each presented question from the student taking the test;
storing the responses to the questions in a memory component;
after a response to a last one of the downloaded set of questions presented on the display is received from the student taking the test using the at least one user interface, analyzing using a processor the responses provided by the student to acceptable responses and based on the analysis of the responses, determining passing of the test using a processor; and
associating passing of the test with the identification of the student provided through the biometric verification in a database,
whereby the random selection of the portion of the set of questions and the random presentation of the downloaded set of questions reduce the likelihood of any two students having the same questions in the same order and thereby reduce the likelihood of any one student taking the test being able to assist another student taking the same test of the course.

13. The method of claim 12, wherein the step of providing tutoring in the course to the student comprises prompting the student to interact with a chatbot to respond to questions asked by the student relating to the segments.

14. The method of claim 12, wherein the step of providing tutoring in the course to the student comprises notifying the student via the telecommunications device of available videos and online courses relating to the segments.

15. The method of claim 12, further comprising segmenting materials for the course into a plurality of segments by partitioning a textbook about the course into sections and generating at least one of audio and video content for each section.

16. The method of claim 12, wherein the step of presenting the set of questions on the display comprises generating the questions using a processor based only on the segment being tested and any segments previously tested.

17. The method of claim 12, wherein the step of presenting the set of questions on the display comprises retrieving, using a processor, a random set of questions from the database that stores questions based only on the segment being tested and any segments previously tested.

18. The method of claim 17, wherein the database is remote from the headset, further comprising downloading using a wireless telecommunications connection the set of questions from the database prior to presenting of the first one of the set of questions on the display so that presentation of the downloaded set of questions is not interrupted by failure of the telecommunications connection.

19. The method of claim 12, wherein the step of performing a biometric verification to provide an identification of the student taking the test comprises using a biometric identification device on the headset to obtain biometric data about the student.

20. The method of claim 12, wherein the step of determining passing of the test using a processor comprises grading the test relative to a threshold.
